(19) United States
(12) Patent Application Publication
(10) Pub. No.: US 2022/0182439 A1
(43) Pub. Date: Jun. 9, 2022

(54) GENERAL GROUPING MECHANISM FOR ENDPOINTS

(71) Applicant: VMware, Inc., Palo Alto, CA (US)

(72) Inventors: Zhengsheng Zhou, Beijing (CN); Xiaopei Liu, Beijing (CN); Wenfeng Liu, Beijing (CN); Donghai Han, Beijing (CN)

(21) Appl. No.: 17/112,689

(22) Filed: Dec. 4, 2020

(51) Int. Cl. H04L 29/08; G06F 9/54; G06F 16/953

(52) U.S. Cl. CPC H04L 67/101; H04L 67/32; G06F 9/542; G06F 9/547; G06F 16/953; H04L 67/16

(57) ABSTRACT

Some embodiments of the invention provide a method for identifying network resources related to an intent-based Application Programming Interface (API) request for a service to be implemented for a network. The method, in some embodiments, is performed by an API server (e.g., executing on a master node) in a Kubernetes network. The API server receives sets of criteria for identifying network resources related to the requested service and sets of instructions for retrieving information associated with network resources identified by the sets of criteria. The sets of criteria and sets of instructions are based on an API request for a resource selector object. The resource selector object, in some embodiments, is a custom resource that is used to define the sets of criteria and the sets of instructions and is based on a custom resource definition (CRD) provided by a user.

### BACKGROUND

In an extensible system of container-based applications that allows users to define custom resources, native system management tools are sometimes inadequate to manage the custom resources. It is desirable to provide custom management tools that can not only manage current custom resources, but will also be able to manage custom resources that are defined in the future. It is further desirable that the custom management tool be compatible with the native system management tools.

### SUMMARY

Some embodiments of the invention provide a method for identifying network resources related to an intent-based Application Programming Interface (API) request for a service to be implemented for a network. The method, in some embodiments, is performed by an API server (e.g., executing on a master node) in a Kubernetes network. The API server receives sets of criteria for identifying network resources related to the requested service and sets of instructions for retrieving information associated with network resources identified by the sets of criteria. The sets of criteria and sets of instructions are based on an API request for a resource selector object. The resource selector object, in some embodiments, is a custom resource that is used to define the sets of criteria and the sets of instructions and is based on a custom resource definition (CRD). CRDs, in some embodiments, are defined by a user or are defined by particular vendors and incorporated by a user.

The API server, in some embodiments, identifies a set of network resources related to the requested service based on the sets of criteria and retrieves information associated with each network resource in the identified set of related network resources using the sets of instructions. The list of identified network resources and the retrieved information are used to populate a set of endpoint data structures (e.g., Endpoints or EndpointSlice APIs in Kubernetes). In some embodiments, only operational network resources in the identified set of related network resources are used to populate the endpoint data structures. The endpoint data structures, in some embodiments, are standard endpoint data structures that are defined for the container-based application management system (e.g., Endpoints or EndpointSlice APIs in Kubernetes). In some embodiments, the endpoint data structures are used to identify network resources (e.g., endpoint groups) used to implement the requested service.

A resource selector controller is provided, in some embodiments, to manage resource selector objects. In some embodiments, a resource selector controller is configured to listen (e.g., to register with the API server) for events relating to resource selector objects. The resource selector controller receives an API request for the resource selector object associated with a particular service from the API server. In some embodiments, the resource selector controller parses the received API and identifies sets of criteria for identifying resources related to the associated service. The resource selector controller generates sets of criteria based on the sets of criteria identified by parsing the received API. The sets of criteria are generated to be understood by the API server to identify network resources that match any of the sets of criteria.

The identified sets of criteria, in some embodiments, include multiple different sets of type-specific criteria for multiple different types of network resources. The multiple different types of network resources include native resource types (i.e., types of network resources defined by the containerized application management system) and network resource types defined by CRDs, in some embodiments. The sets of type-specific criteria for different network resource types may include different criteria for a same set of attributes, the same (or equivalent) criteria for a same set of attributes, or a mixture of attributes including a set of attributes that have different criteria and a set of attributes that have a same criteria. For example, criteria for two different network resource types may specify different labels (e.g., values or strings) for “apiVersion” and “kind” (e.g., for a virtual network interface specifying [apiVersion: vmware.com/v1alpha1, kind: VirtualNetworklnterface] and for a Pod specifying [apiVersion: v1, kind: Pod]) while specifying a same label for a “namespace” attribute (e.g., [namespace: testNamespace]).

The resource selector controller, in some embodiments, also parses a received resource selector API to identify sets of queries for retrieving information regarding network resources. As for the sets of criteria, the sets of queries, in some embodiments, include sets of type-specific queries to retrieve information necessary to populate the set of endpoint data structures. The type-specific queries, in some embodiments, are specified as JavaScript Object Notation (JSON) Matching Expression Paths (JMESPath) queries in the resource selector API. The resource selector controller generates, based on the identified sets of queries, sets of queries that can be understood by the API server to retrieve the information for populating the set of endpoint data structures, in some embodiments.

The resource selector controller generates an API for populating a set of endpoint data structures, in some embodiments, and provides the generated API to the API server to populate the set of endpoint data structures. In some such embodiments, the resource selector controller registers for notifications related to network resources that match any of the sets of criteria identified from the resource selector API for identifying a network resource as relating to a particular service. The API server, in some embodiments, monitors the network resources (e.g., by monitoring a YAML (YAML Ain't Markup Language) file or other similar hierarchical document or file that identifies the components of the monitored network) to generate an initial list of candidate network resources that are related to the service based on the sets of criteria from the resource selector controller. The monitoring also identifies subsequent changes to the list of network resources related to the service. The API server sends the list of candidate network resources related to the service to the resource selector controller.

The resource selector controller, in some embodiments, evaluates the sets of type-specific queries identified for retrieving information necessary to populate the set of endpoint data structures. In some embodiments, the resource selector controller performs the queries on the list of candidate network resources related to the service that it receives from the API server. In other embodiments, the resource selector controller sends sets of queries to the API server to be evaluated and have the results returned to the resource selector controller to use to populate an endpoint data structure (e.g., an Endpoints API or EndpointSlice API). The set of queries in some embodiments, is generated based on the sets of queries in the resource selector API and the received list of candidate network resources related to the service. The results of the queries, in some embodiments, include a status variable that indicates whether a candidate network resource is operational for at least some of the network resources in the list of candidate network resources related to the service. In some embodiments, information associated with network resources for which the status variable indicates that the network resource is not operational is not included in the endpoint data structure.

The resource selector controller, in some embodiments, not only receives updates to the list of network resources that are related to the service but also sends updates to the sets of criteria and the sets of queries based on changes to the resource selector associated with a service. In embodiments in which the resource selector controller generates an API for generating the set of endpoint data structures at the API server, the resource selector controller also generates updated APIs to send to the API server upon changes to the network resources related to the service (e.g., either a change in the membership of the list or in the reported attributes). In some embodiments, the list of candidate network resources, sets of queries, and APIs to generate the endpoint data structures are sent periodically either in addition to or as an alternative to sending only upon changes.

The set of endpoint data structures, in some embodiments, is used by a set of service engines that facilitate the service requested by the first API. The set of service engines, in some embodiments, is configured to perform load balancing for a set of network resources (e.g., sometimes referred to as service nodes, endpoints, or end nodes) that are used to provide or implement the service. The set of network resources, in some embodiments, is defined by the set of endpoint data structures populated by the API server based on the input received from the resource selector controller. In some embodiments, the set of service engines register with the API server to receive the set of endpoint data structures associated with the requested service when they receive the request to facilitate the service. Based on the registration, the API server in some embodiments, sends the set of endpoint data structures as they are created or updated. Additionally, or alternatively, the endpoint data structures are sent to the service engines periodically by the API server.

In some embodiments, a set of service engine controllers manages the set of service engines. The set of service engine controllers registers for notifications relating to services and endpoints. Once a particular service facilitated by service engines that a service engine controller manages is deployed, a service engine controller, in some embodiments, receives updates to a set of endpoint data structures related to the service and provides either the received set of endpoint data structures, or information based on the received set of endpoint data structures to the service engines facilitating the service. For example, a service engine controller, in some embodiments, generates load balancing rules based on the set of network resources identified in the set of endpoint data structures.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings and the Claims is needed. Moreover, the claimed subject matters are not to be limited by the illustrative details in the Summary, the Detailed Description, and the Drawing.

### BRIEF DESCRIPTION OF FIGURES

The novel features of the invention are set forth in the appended claims. However, for purposes of explanation, several embodiments of the invention are set forth in the following figures.

FIG. 1 illustrates an example of a control system of some embodiments of the invention.

FIG. 2 conceptually illustrates a process performed by an API server to process API requests for a service and a resource selector.

FIG. 3 illustrates an exemplary service API, resource selector CRD, and resource selector API.

FIG. 4 conceptually illustrates a process performed by an API server for generating a set of endpoint data structures and providing the generated set of endpoint data structures to a service engine controller.

FIG. 5 conceptually illustrates a process that is performed by a resource selector controller of some embodiments to generate a set of endpoint data structures associated with a service.

FIG. 6 illustrates an embodiment of a resource selector controller that performs the process illustrated in FIG. 5.

FIGS. 7A-D illustrate an embodiment of the control system in which the resource selector controller provides the API server with selection criteria and a set of attribute queries that the API server uses to populate a set of endpoint data structures.

FIG. 8 conceptually illustrates a process for a service engine controller to manage a set of service engines used to facilitate a requested service.

FIG. 9 illustrates a complete set of operations for a particular embodiment of the network control system using resource selectors.

FIG. 10 illustrates a CRD for a virtual network interface and two APIs defining two VIFs related to the service.

FIG. 11 illustrates a set of query results of the JMESPath queries specified in the resource selector API and Endpoints and EndpointSlice APIs generated based on the resource selector API and the related VIFs.

FIG. 12 illustrates APIs for two machines that are defined by a CRD and are related to the service defined in FIG. 3.

FIG. 13 illustrates a resource selector API for identifying the VSphereMachines defined by the APIs of FIG. 12 as being related to the service and Endpoints and EndpointSlice APIs generated based on the resource selector API and the related VSphereMachines.

FIGS. 14A and B illustrate APIs for two Pods that are native Kubernetes resources and are related to the service defined by the API of FIG. 3.

FIG. 15 illustrates a resource selector API for identifying the Pods defined by the APIs of FIG. 14 as being related to the service and Endpoints and EndpointSlice APIs generated based on the resource selector API and the related Pods.

FIG. 16 illustrates an exemplary resource selector that is defined using multiple type-specific sets of criteria and multiple type-specific sets of queries.

FIG. 17 illustrates an exemplary resource selector that is defined to populate an Endpoints API and EndpointSlice API with information relating to multiple network resource types related to the service defined by the API of FIG. 3.

FIG. 18 illustrates an Endpoints API generated based on the resource selector of FIG. 17 and network resources generated by APIs illustrated in FIGS. 10 and 14A and B.

FIG. 19 illustrates a network policy API that defines a network policy in terms of resource selectors and the resource selector APIs defining the resource selectors used to define the network policy.

FIG. 20 illustrates EndpointSlice APIs generated based on resource selector APIs specified for a network policy.

FIG. 21 illustrates an example of distributed load balancer that is defined for several machines on several host computers and that uses a set of endpoint data structures generated based on a resource selector to identify network resources to which to distribute load balanced data messages.

FIG. 22 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for identifying network resources related to an intent-based Application Programming Interface (API) request for a service to be implemented for a network. The method, in some embodiments, is performed by an API server (e.g., executing on a master node) in a Kubernetes network. The API server receives sets of criteria for identifying network resources related to the requested service and sets of instructions for retrieving information associated with network resources identified by the sets of criteria. The sets of criteria and sets of instructions are based on an API request for a resource selector object. The resource selector object, in some embodiments, is a custom resource that is used to define the sets of criteria and the sets of instructions and is based on a custom resource definition (CRD) provided by a user.

Several more detailed examples of some embodiments will now be described. In these examples, Kubernetes-based systems will be used as an exemplary container-based application management system. These embodiments use CRDs to define additional network resources that complement the Kubernetes native resources. One of ordinary skill will realize that the Kubernetes-based systems are only used as an exemplary extensible container-based application management system and that the methods described below are applicable to other extensible container-based application management systems.

As used in this document, data messages refer to a collection of bits in a particular format sent across a network. One of ordinary skill in the art will recognize that the term data message is used in this document to refer to various formatted collections of bits that are sent across a network. The formatting of these bits can be specified by standardized protocols or non-standardized protocols. Examples of data messages following standardized protocols include Ethernet frames, IP packets, TCP segments, UDP datagrams, etc. Also, as used in this document, references to L2, L3, L4, and L7 layers (or layer 2, layer 3, layer 4, and layer 7) are references respectively to the second data link layer, the third network layer, the fourth transport layer, and the seventh application layer of the OSI (Open System Interconnection) layer model.

As used in this document, the term network resource is a general term that encompasses Pods, virtual machines (VMs), custom resources defined in CRDs, or any resource available to implement a requested service. Network resources that implement a service may be referred to as service nodes, end nodes, endpoints, or other similar terms. Network resources identified as being related to a service by a resource selector described herein are sometimes referred to in some instances as endpoint groups.

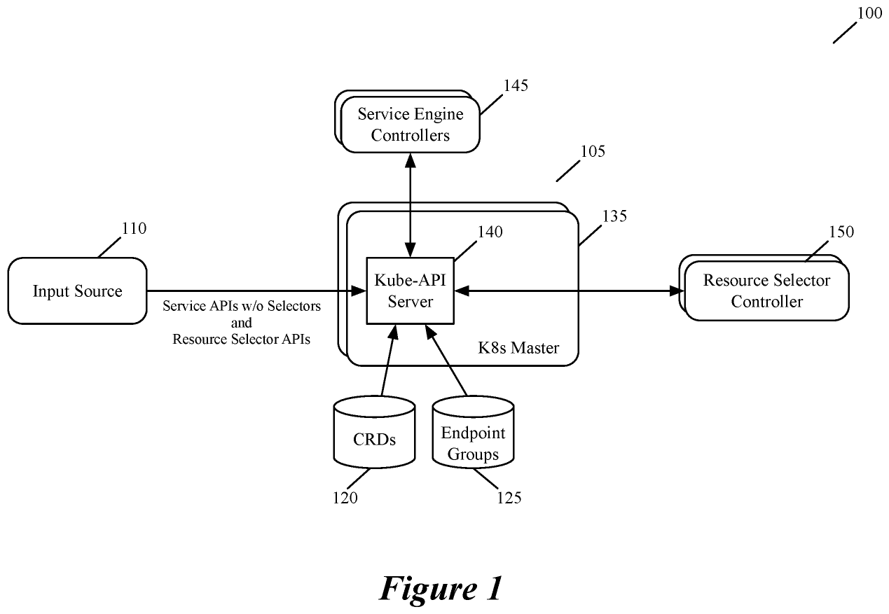

FIG. 1 illustrates an example of a control system 100 of some embodiments of the invention. This system 100 processes APIs that use the Kubernetes-based declarative model to describe the desired state of (1) the machines to deploy, and (2) the connectivity, security and service operations that are to be performed for the deployed machines (e.g., private and public IP addresses connectivity, load balancing, security policies, etc.). To process these APIs, the control system 100 uses one or more CRDs to define some of the resources referenced in the APIs.

As shown, the control system 100 includes an API processing cluster 105. The API processing cluster 105 includes two or more API processing nodes 135, with each node comprising an API processing server 140. The API processing server 140 receives intent-based API calls and parses these calls. Some API calls are received from an input source 110. In some embodiments, the received API calls are in a declarative, hierarchical Kubernetes format, and may contain multiple different requests. In some embodiments, at least one set of received API calls includes an API call to deploy a service and an API call to deploy a resource selector for the service. The API call for the resource selector refers to a custom resource definition stored as a CRD 120, in some embodiments.

The API processing server 140 parses each received intent-based API request into one or more individual requests. When the requests relate to the deployment of machines, the API server 140 provides these requests directly to a set of compute managers and controllers (not shown), or indirectly provide these requests to the compute managers and controllers through an agent running on the Kubernetes master node 135. The compute managers and controllers then deploy VMs and/or Pods on host computers.

In some embodiments, the API calls refer to custom resources that are not defined per se by Kubernetes. For these references, the API processing server 140 uses one or more CRDs 120 to interpret the references in the API calls to the extended resources. The CRDs 120 in some embodiments include the resource selector, a virtual network interface (VIF or vnetif), and a VSphereMachine. In some embodiments, the CRDs 120 are provided to the API processing server 140 in one stream with the API calls.

The system 100 also includes a set of resource selector controllers 150 that communicates with the API server 140 to monitor and manage a set of resource selectors. The resource selector controller 150, in some embodiments, registers for event notifications with the API server 140, e.g., sets up a long-pull session with the API server 140 to receive all CRUD (Create, Read, Update and Delete) events related to resource selector objects. Additionally, in some embodiments, the resource selector controller 150, registers for event notifications with the API server 140 for events related to a set of network resources matching at least one set of criteria specified in a resource selector object managed by the resource selector controller 150. A resource selector controller 150 is a custom controller (e.g., controller program) configured to manage resource selector objects and facilitate, based on the resource selector objects it manages, the generation of Endpoints APIs (or EndpointSlice APIs) that are consumed by the native Kubernetes system. While the terms Endpoints API and EndpointSlice API are used often in the description it will be understood by one of ordinary skill in the art to encompass any API or data structure (e.g., file, document, API call, etc.) that specifies a group of network resources that can be consumed by other elements of a container-based application management system.

The Endpoints APIs, in some embodiments, are each associated with a particular resource selector object that defines the network resources (e.g., machines, Pods, custom resources, etc.) related to a particular service. In some embodiments, a particular service for which a resource selector is specified will not include a “selector” that identifies related network resources in the service definition (i.e., in the REST (Representational State Transfer) object posted to the API server 140). As will be discussed below, the resource selector, and particularly the resource selector controller, are configured such that they can identify any type of network resource (i.e., native Kubernetes resources or non-native resources based on CRDs) for inclusion in the Endpoints APIs. A user can use the resource selector controller 150 and resource selector CRD to define groups of network resources for existing and yet-to-be-created resource types without having to write a custom controller program. As will be discussed below in more detail, once a new resource type is defined (e.g., in a CRD) it can be monitored by the resource selector controller 150 and added to an Endpoints API based on a knowledge of its attributes and specification. One of ordinary skill in the art will appreciate that the resource selector controller and resource selector CRD are configured slightly differently for different container-based application management systems to generate a list of network resources that can be consumed by a particular container-based application management system in which they are deployed.

The system 100 also includes a set of service engine controllers 145 that communicates with the API server 140 to monitor and manage a set of service engines. The set of service engine controllers 145, in some embodiments, registers for event notifications with the API server 140, e.g., sets up a long-pull session with the API server 140 to receive all CRUD events related to the set of service engines. In some embodiments, the events related to the set of service engines includes all CRUD events related to services and endpoints. In other embodiments, the events related to the set of service engines includes CRUD events related to services and endpoints related to a set of services facilitated by the set of service engines managed by the set of service engine controllers 145. The endpoint data structures, in some embodiments, are stored as endpoint groups in an endpoint groups data structure 125 (e.g., as an Endpoints API, a YAML file, or other hierarchical data structure). In some embodiments, endpoint groups are stored in a YAML file that includes information for the entire network or for all resources in a particular set of namespaces, clusters, or other level of network hierarchy.

The service engines, in some embodiments, provide a service to facilitate a particular requested service. In some embodiments, services including L4/L7 load balancing, distributed load balancing, discovery via DNS (Domain Name System), discovery via DNS with artificial endpoints, etc. are performed by the service engines. The service engines, in some embodiments, consume Endpoints APIs (or use information derived from an Endpoints API) to provide the service. For example, in providing L4 load balancing for a particular service, the service engines identify the service nodes (e.g., virtual machines, Pods, etc.) among which it will distribute data messages destined for the service (e.g., having a destination IP that is a virtual IP associated with the service) based on a set of IP (Internet Protocol) addresses included in an Endpoints data structure.

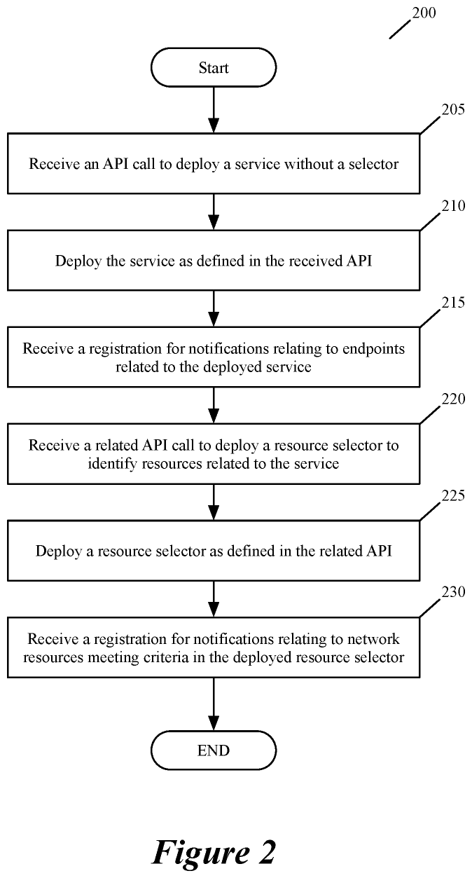

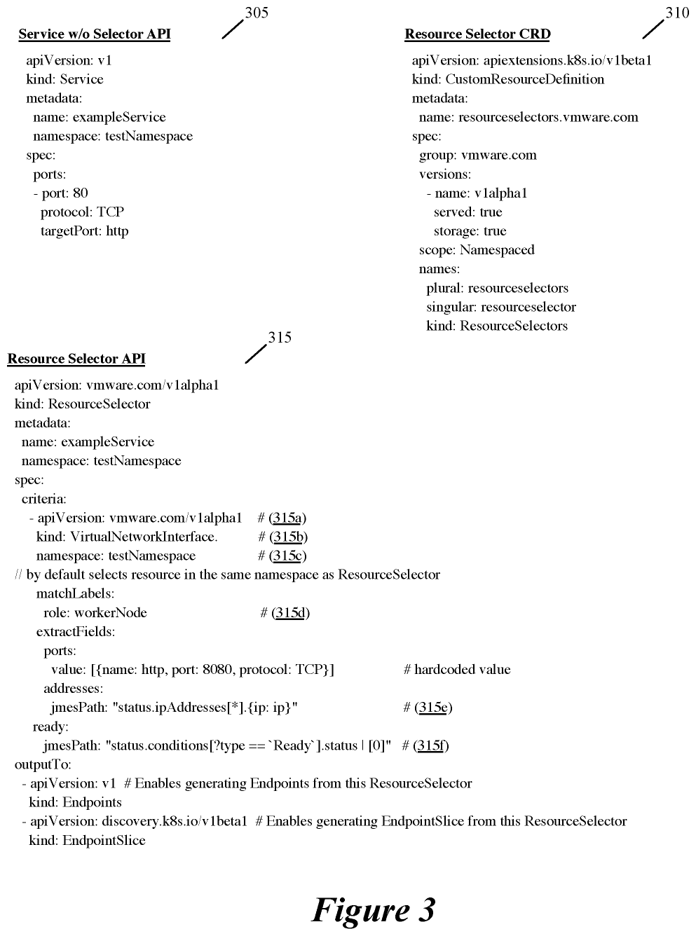

FIG. 2 conceptually illustrates a process performed by an API server (e.g., API server 140), in some embodiments, to process API requests (calls) for a service and a resource selector. Process 200 will be described in relation to FIG. 3 which illustrates an exemplary service API 305, resource selector CRD 310, and resource selector API 315. The process 200 assumes that at least one service engine controller and resource selector controller have been deployed and have registered with the API server performing the process 200 for event notifications relating to services and resource selectors, respectively. The process 200 begins by receiving (at 205) an API call to deploy a particular service. The API call defines a service, but does not define a “selector” for the service that identifies service nodes (e.g., network resources, machines, external resources, Pods, etc.) that will provide the requested service. An exemplary service API that does not include a selector is illustrated in API 305 of FIG. 3.

Based on the API call received (at 205) the API server deploys (at 210) the service as defined in the API call. As noted above, deploying the service, in some embodiments, includes providing the API call (request) directly or indirectly to a set of compute managers and controllers to deploy resources for the service. As shown in FIG. 3, a service API, in some embodiments, specifies a port and a protocol. If, as in the example provided in FIG. 3, no IP address is specified for the service, some embodiments assign an IP address to the service (e.g., a cluster-internal IP) as part of deploying the service. Service APIs, in some embodiments, can specify a specific cluster-internal IP address, an external IP address, or both.

After the service is deployed, the API server receives (at 215) a registration for notifications relating to endpoints related to the deployed service. In some embodiments, the registration is a long-pull session with the API server to receive all CRUD events related to endpoint data structures related to the deployed service (e.g., Endpoints APIs sharing a name with the service). Because there is no selector identified in the service definition, in some embodiments, there is no endpoint data structure defined for the service upon receiving the registration.

The API server also receives (at 220) an API for a resource selector to deploy a resource selector (e.g., resource selector API 315). The API call refers to a resource selector CRD (e.g., resource selector CRD 310) and defines sets of criteria for identifying network resources associated with the service (e.g., service nodes used to provide the service). The sets of criteria, in some embodiments, include different sets of criteria for different resource types (e.g., Pods, VIFs, or other non-native resource types). The sets of type-specific criteria specify attributes that are defined for the specific resource type. In some embodiments, a first set of criteria in the type-specific criteria identify the resource type (e.g., an “apiVersion” and “kind”) and the namespace in which the resource operates (e.g., criteria 315a-c of FIG. 3). A second set of type-specific criteria is specified, in some embodiments, that identifies specific resources of the resource type that are associated with the service (e.g., VIFs labeled with “role: workerNode” as in criterion 315d of FIG. 3). One of ordinary skill in the art will understand that more than one label can be specified in the second set of criteria and that the first and second sets of type-specific criteria are referred to collectively as a set of type-specific criteria.

Based on the API for the resource selector received (at 220) the API server deploys (at 225) the resource selector. In some embodiments, deploying the resource selector includes sending the resource selector API (or the definition of the resource selector contained in the API) to the resource selector controller. The resource selector controller, in some embodiments, then sends a registration for CRUD events related to any network resource matching any of the sets of type-specific criteria to the API server. The API server receives (at 230) the registration and the sets of type-specific criteria and the process ends.

Process 200, in some embodiments, is performed for each new service requested at the API server. If a service definition or resource selector definition are modified operations 205-215 or 220-230 are performed, respectively, in some embodiments. The API calls related to the service and the resource selector, in some embodiments, are received as a single API (combing operations 205 and 220) that is parsed into its component parts to identify the separate service and resource selector APIs before performing the subsequent operations. One of ordinary skill in the art will appreciate that the operations need not be, and will not be, performed in the specific order illustrated in other embodiments. For example, operations 205 and 220 may be performed simultaneously as described above, or deployment operations 210 and 225 may be performed before receiving registrations from the service engine and resource selector controllers at operations 215 and 230.

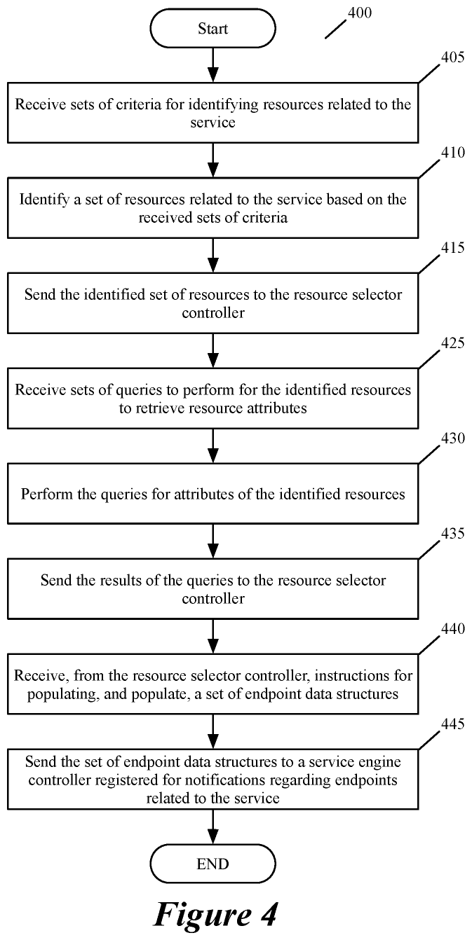

FIG. 4 conceptually illustrates a process 400 performed by an API server for generating a set of endpoint data structures (e.g., Endpoints or EndpointSlice APIs) and providing the generated set of endpoint data structures to a service engine controller. Process 400, in some sense can be considered a continuation of process 200 and begins by receiving (at 405) sets of criteria for identifying resources related to a service based on the definition of a resource selector associated with the service. Operation 405, in some embodiments, is equivalent to operation 230 of process 200. The sets of criteria received (at 405), in some embodiments, include different sets of type-specific criteria for different resource types that may be included in the set of network resources associated with a particular service. In other embodiments, there is only single set of criteria (e.g., type-specific criteria for a custom resource type). In some embodiments, the sets of criteria are received (at 405) as a set of queries for network resources that meet any set of type-specific criteria in the sets of criteria specified in the resource selector API.

Based on the received sets of criteria, the API server identifies (at 410) a set of network resources (e.g., VIFs, virtual machines, Pods, custom resources, etc.) that are related to the service. In some embodiments, the API server queries a YAML file or other similar hierarchical document or file that identifies available network resources (e.g., network resources in namespaces identified in the sets of criteria, network resources available in an availability zone in which the service is provided, etc.) to identify network resources matching at least one set of type-specific criteria. The queries, in some embodiments, are provided by the resource selector controller. In other embodiments the queries are derived from the registration for CRUD events received (e.g., at 230) from the resource selector controller.

The set of network resources identified as related to the service are sent (at 415) to the resource selector controller. In some embodiments, the identified set of network resources is also stored locally to identify any changes to the set of network resources related to the service in order to send updates to the resource selector controller. In some embodiments, sending the identified set of resources to the resource selector controller includes sending a document or file (e.g., a YAML file) that includes the specification for each network resource in the set of network resources. In other embodiments, sending the identified set of resources to the resource selector controller includes sending network resource identifiers and associated resource types.

After sending (at 415) the set of network resources identified as related to the service to the resource selector controller, the API server, in some embodiments, receives a set of queries to perform to retrieve information regarding attributes of the identified set of network resources that are used to populate a set of endpoint data structures associated with the service. The received set of queries, in some embodiments, includes type-specific queries for each type of resource included in the identified set of network resources. In some embodiments, the queries for each resource type are specified as JavaScript Object Notation (JSON) Matching Expression Paths (JMESPath) that are based on the structure of the resource specification or definition (e.g., in a CRD) to extract the information regarding attributes of the resource used to populate the endpoint data structures. For example, resource selector 315 includes JMESPath queries 315e and 315f.

Based on the received set of queries, the API server performs (at 430) the queries to retrieve the attribute information for the identified set of network resources. In some embodiments, the attribute information for a network resource includes at least an IP address and a status variable indicating whether the network resource is operational or available (e.g., a “ready” attribute). The retrieved attribute information for some resource types, in some embodiments, includes information regarding ports on which the network resources listen (e.g., exposed ports) and protocols associated with the ports.

The retrieved attribute information is then sent (at 435) to the resource selector controller. The resource selector controller, in some embodiments, uses the retrieved status information to generate a set of instructions to populate a set of endpoint data structures. In some embodiments, the generated set of instructions includes a set of attributes for each of the identified network resources that were identified as being available. The set of attributes for a particular resource, in some embodiments, include an IP address, a set of attributes specified in the set of type-specific criteria for the resource type, and a port and protocol associated with the resource type. In some embodiments, the set of instructions is an API (e.g., an Endpoints API or EndpointSlice API) that is specified as the output of the resource selector in the received definition of the resource selector.

The API server then receives the generated set of instructions for populating a set of endpoint data structures and populates (at 440) the endpoint data structures based on the received set of instructions. In embodiments in which the set of instructions is an Endpoints API or EndpointSlice API, populating the set of endpoint data structures includes storing the Endpoints or EndpointSlice object defined in the API in an endpoint group data storage (e.g., a specific location in the YAML that defines the network).

The set of endpoint data structures is then sent (at 445) to service engine controllers that have registered for notifications relating to the endpoint data structures associated with the service. The service engine controllers, in some embodiments, then supply the endpoint data structures, or information derived from the endpoint data structures, to service engines facilitating the service to identify service nodes associated with the service. The service engines can then perform a service (e.g., load balancing) for the identified service nodes.

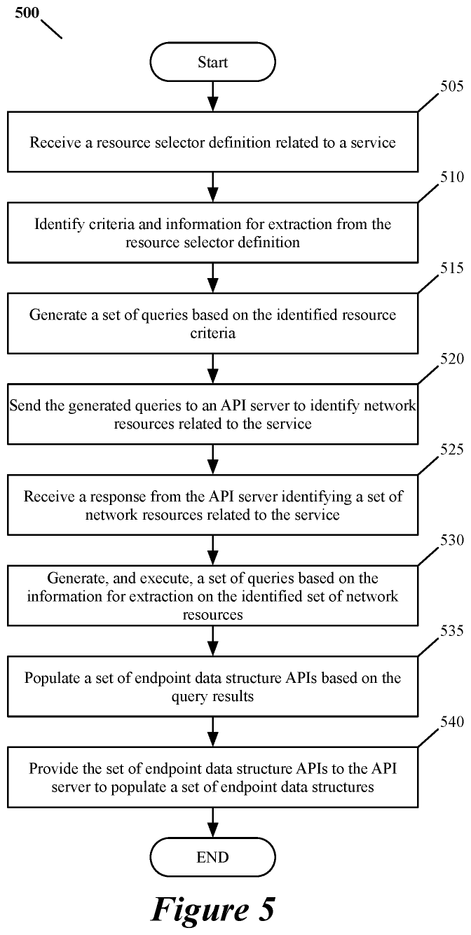

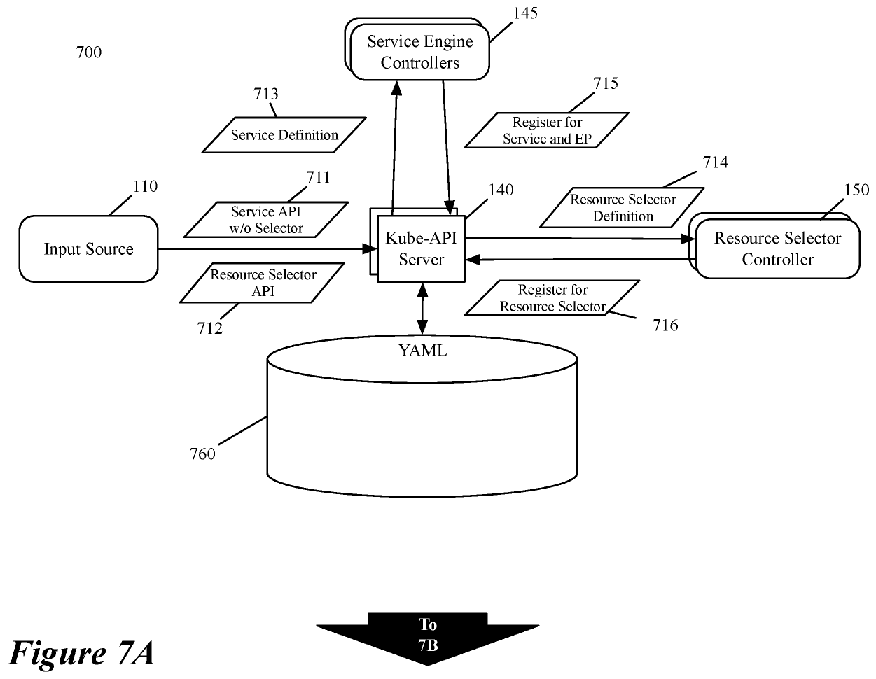

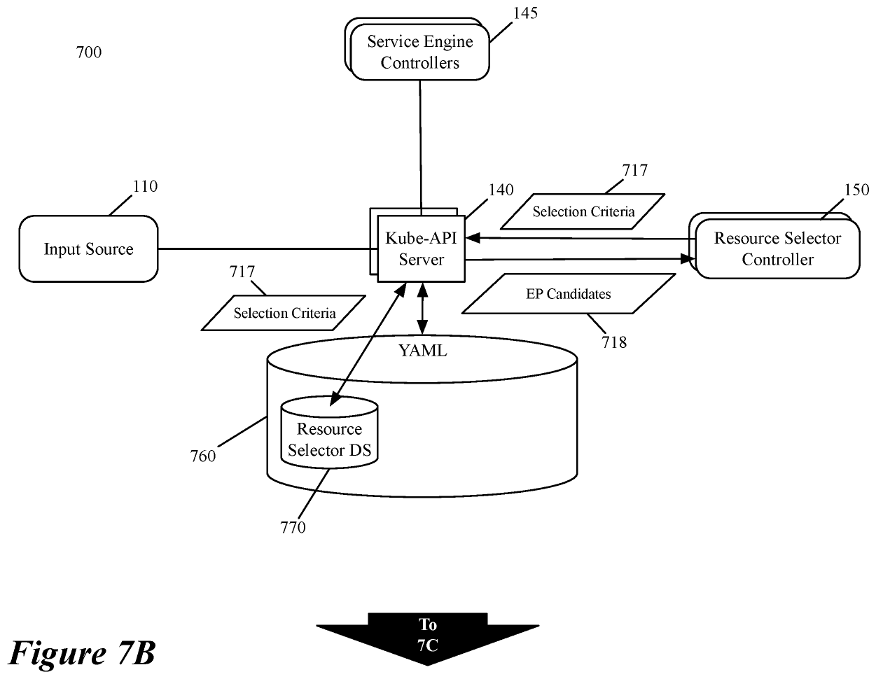

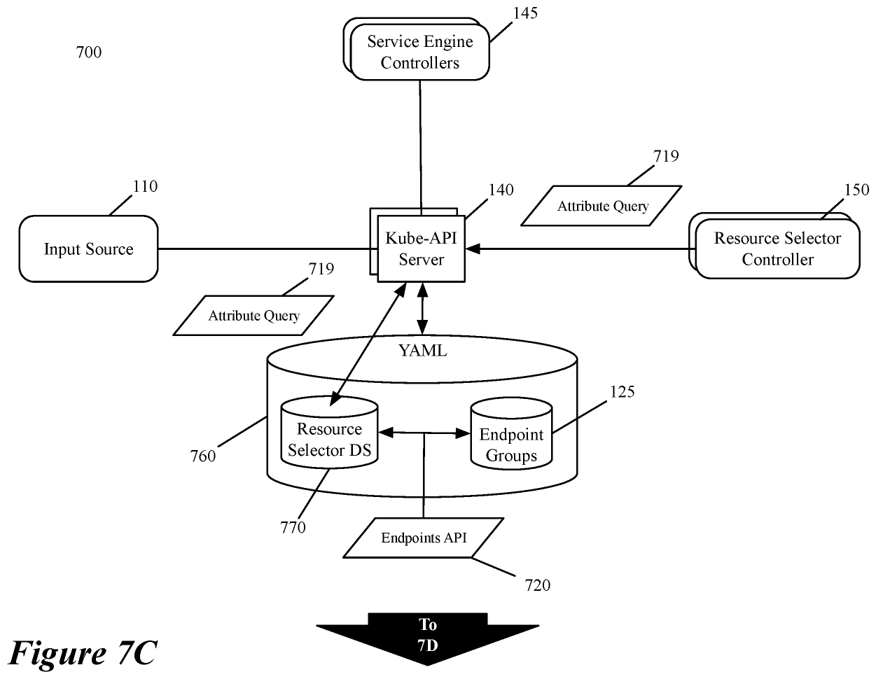

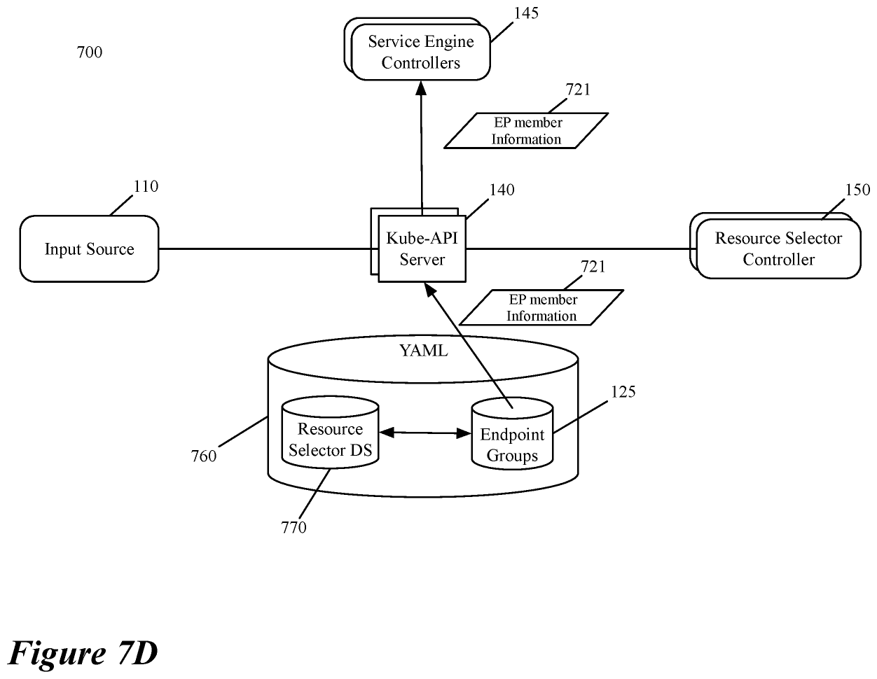

One of ordinary skill in the art will appreciate that the operations of process 400, in some embodiments, are rearranged or performed by different elements of the control system. Some other embodiments are discussed below in reference to FIGS. 5, 6, 7A-D. For example, FIG. 5 conceptually illustrates a process 500 in which 425-435 are not performed by the API server and are instead replaced by operations 530 and 535. FIGS. 7A-D illustrate a set of operations in which operations 435 and 440 are replaced by an operation that directly populates a set of endpoint data structures based on the identified set of network resources stored locally by the API server and a set of attributes of the identified set of network resources retrieved based on a set of queries received from a resource selector controller.

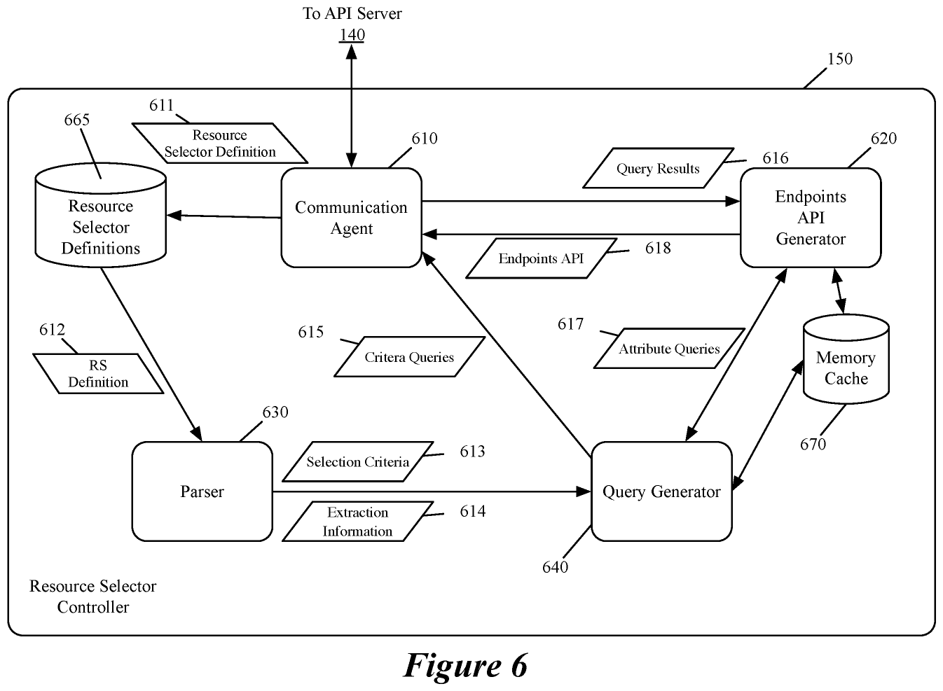

FIG. 5 conceptually illustrates a process 500 that is performed by a resource selector controller, in some embodiments, to generate a set of endpoint data structures associated with a service. Process 500 will be described in conjunction with FIG. 6 which illustrates an embodiment of a resource selector controller that performs the process 500. Process 500 begins by receiving (at 505) a resource selector definition related to a particular service. As described above in relation to FIGS. 2, 3, and 4, the resource selector definition, in some embodiments, is a resource selector API (e.g., API 315) or YAML file that includes sets of criteria for identifying network resources related to the service (e.g., criteria 315a-d) and a set of queries to extract information regarding attributes of identified network resources (e.g., JMESPath queries 315e and 315f). As shown in FIG. 3, some embodiments specify information regarding a set of attributes as hard coded values instead of as queries (e.g., the ports values of resource selector API 315). FIG. 3 also illustrates that the resource selector API, in some embodiments, includes an “outputTo” instruction to output the retrieved attribute information to an Endpoints or EndpointSlice object (e.g., an API for generating the object).

FIG. 6 illustrates a communication agent 610 of a resource selector controller 150 that, in some embodiments, receives (at 505) the resource selector definition. The resource selector definition 611, in some embodiments, is then stored in a data structure 665 of the resource selector controller 150 for storing resource selector definitions for multiple services. The resource selector definition (e.g., RS definition 612) is then provided, in some embodiments, to a parser 630 to identify (at 510) criteria for identifying network resources related to the service (e.g., selection criteria 613) and information for extraction (e.g., extraction information 614) from the resource selector definition.

The identified criteria, in some embodiments, are used to generate (515) a set of queries to send to the API server to identify network resources that are related to the service. In some embodiments, the identified criteria (e.g., selection criteria 613) are sent to a query generator 640 that generates the set of queries. The query generator 640, in some embodiments, sends the generated query for network resources related to the service to the communication agent 610.

The communication agent 610 then sends (at 520) the generated query to the API server for the API server to identify the network resources related to the service. The API server performs an operation similar to operation 410 described above in relation to FIG. 4 to identify the network resources related to the service by applying the queries to a document or file (or set of documents) that identifies network resources. The API server then sends the identified set of related network resources to the resource selector controller (as in operation 415).

The resource selector controller receives (at 525) the identified set of related network resources from the API server. As shown in FIG. 6, communication agent 610 supplies query results 616 received from the API server (not shown) to an Endpoints API generator 620. In some embodiments, the query results include a complete data structure defining each identified network resource (e.g., a complete YAML file or API definition).

The resource selector controller 150 generates (at 530) and executes a set of queries (e.g., attribute queries 617) on the identified set of related network resource to extract attribute information related to the identified set of related network resources. In some embodiments, the set of queries on the identified set of related network resources is generated (e.g., at query generator 640) based on the queries identified from the resource selector definition (e.g., extraction information 614) and the resource types included in the identified set of related network resources (e.g., query results 616). For example, the set of queries is generated to include only the type-specific queries for the types of network resources included in the identified set of related network resources. In other embodiments, the attribute queries are generated based solely on the queries identified from the resource selector definition (e.g., extraction information 614).

In some embodiments, an Endpoints API generator 620, receives the set of queries (e.g., attribute queries 617) from query generator 640 and executes the set of queries to extract the attribute information. As described above, the extracted attribute information, in some embodiments, includes at least an IP address and a status variable indicating whether the network resource is operational or available (e.g., a “ready” attribute). The retrieved attribute information for some resource types, in some embodiments, includes information regarding ports on which the network resources listen (e.g., exposed ports) and protocols associated with the ports.

Based on the results of the set of queries for attribute information the resource selector controller populates (at 535) a set of endpoint data structures. In some embodiments, the Endpoints API generator 620 populates an Endpoints API or EndpointSlice API (e.g., based on the type of output specified in the resource selector definition) based on the results of the query to the API server and the set of queries for the attribute information. For example, based on the results of the queries for the attribute information, the Endpoints API generator 620 will populate an Endpoints API (Endpoints 618) with criteria specified in the resource selector definition (e.g., “apiVersion,” “kind,” and “namespace”) as well as retrieved attribute information (e.g., IP address and ports) for all identified resources that are indicated as operational (or available) based on the retrieved attribute information. In some embodiments, some of the criteria will be different for different resource types (e.g., “apiVersion” and “kind”) while some criteria will be the same across resource types (e.g., “namespace”).

After populating (at 535) the set of endpoint data structures, the resource selector controller 150 provides the set of endpoint data structures (e.g., the Endpoints API 618) to the API server. In some embodiments, the Endpoints API generator 620 sends Endpoints API 618 that was generated to communication agent 610 to send the Endpoints API 618 to the API server. The API server processes the Endpoints API 618 to populate the endpoint data structures. In some embodiments, the API structure merely adds the definition of the Endpoints object included in the Endpoints API 618. The set of endpoint data structures can then be provided by the API server to the service engine controllers or service engines that have registered for notifications for either generic endpoints or for the specific endpoints related to the service. In some embodiments, the API generator 620 and query generator 640 use a memory cache 670 to cache the results of their operations.

FIGS. 7A-D illustrate an embodiment of the control system 700 in which the resource selector controller 150 provides the API server 140 with selection criteria and a set of attribute queries that the API server uses to populate a set of endpoint data structures. FIG. 7A illustrates the API server 140 receiving a set of APIs to deploy the service (711) and to deploy the resource selector (712) from an input source 110. One of ordinary skill in the art will appreciate that the two APIs, in some embodiments, are provided as a single API that is parsed into separate APIs at the API server. The API server 140 then deploys the service and the resource selector and sends the service definition 713 to the service engine controllers 145 and the resource selector definition 714 to the resource selector controllers 150. In some embodiments, deploying the service and the resource selector is accomplished by sending the definitions to the respective controllers, while other APIs are received to deploy specific network resources (e.g., Pods, VMs, machines, etc.) for providing the service (i.e., the network resources identified as related to the service). The service engine controllers 145 then send a registration 715 for events relating to the service and endpoints, and the resource selector controllers 150 send a registration 716 for events relating to the resource selector, to API server 140.

FIG. 7B illustrates the set of resource selector controllers 150 sending sets of selection criteria 717 to the API server 140. The sets of selection criteria 717, in some embodiments, are sent by resource selector controllers 150 to register for notifications of events related to network resources matching any set of selection criteria in the sets of selection criteria 717. As discussed above the sets of selection criteria, in some embodiments, include type-specific sets of criteria for different types of network resources. The API server 140 stores the selection criteria, in some embodiments, in a resource selector data structure 770 within YAML 760. Based on the selection criteria 717, the API server identifies a set of endpoint candidates 718 (i.e., a set of network resources that are related to the service and that may be included in a set of endpoint data structures) to the resource selector controller 150.

FIG. 7C illustrates that, based on the set of endpoint candidates, the resource selector controller 150 generates a set of attribute queries to retrieve attribute information for the set of endpoint candidates and sends the set of attribute queries 719 to the API server 140 to perform the queries on the identified set of endpoint candidates. The generation of the attribute queries based on the set of identified endpoint candidates is discussed in more detail above in relation to operation 530 of FIG. 5. API server 140 receives the results of the set of attribute queries 719 and, based on the identified set of endpoint candidates and the results of the set of attribute queries, populates an endpoint data structure (e.g., Endpoints API 720) in an endpoint groups data structure 125.

FIG. 7D illustrates the API server 140 retrieving the information regarding the endpoints (e.g., EP (endpoint) member information 721) stored in an endpoint groups data structure 125 (e.g., as an Endpoints API, a YAML file, or other hierarchical data structure). The EP member information 721 is then provided to the service engine controllers 145 (or in other embodiments, directly to a set of service engines that have registered with the API server for the endpoint information). The service engine controllers receive the information based on the registration 715 and provide information regarding the network resources (e.g., endpoints) related to the service to the service engines that facilitate the service (e.g., by providing load balancing across the identified endpoints). One of ordinary skill in the art will appreciate that subsets of the operations 717-721 and similar operations in FIGS. 4, 5, 6, and 8 are performed each time there is a change to any of a resource definition, a set of identified candidate endpoints based on a resource definition, or a set of endpoints included in the endpoint data structure.

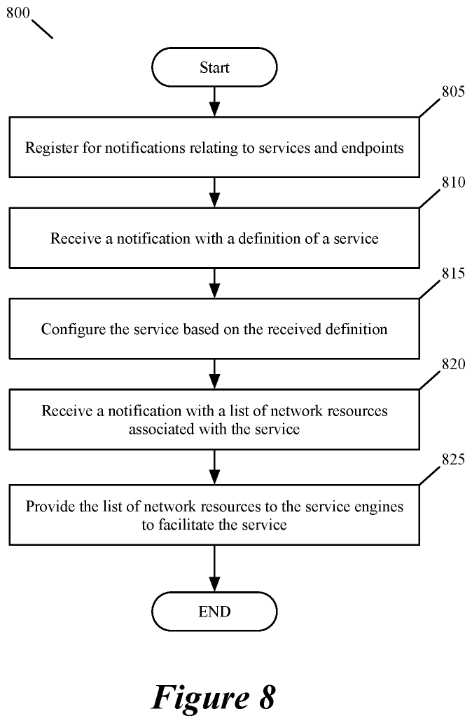

FIG. 8 conceptually illustrates a process 800 for a service engine controller to manage a set of service engines used to facilitate a requested service. The process begins by registering (at 805) for event notifications with an API server, e.g., setting up a long-pull session with the API server to receive all CRUD events related to the set of service engines (e.g., Service definitions and Endpoints or EndpointSlice APIs). In some embodiments, this registration is a standard operation for a service engine controller upon startup.

Based on the registration (at 805), the service engine controller receives (at 810) a notification of a service definition (e.g., from operation 210 of FIG. 2). The notification of the service definition, in some embodiments, is a service API that specifies a service name, a namespace, and a port that is exposed to provide the service as illustrated in service API 305 of FIG. 3. The service engine controller then configures (at 815) the service based on the service definition received (at 810) from the API server. In some embodiments, configuring the service includes configuring the service engines to expose the ports specified for the service. Configuring the service also includes, in some embodiments, configuring the service engines to provide one or more of L4 or L7 load balancing, distributed load balancing, discovery via DNS (Domain Name System), discovery via DNS with artificial endpoints, etc. for the service (e.g., for the service nodes or end nodes implementing of performing the service).

After the endpoint data structures are populated by any of the processes described above in FIGS. 4-7 or any other similar process, the service engine controllers receive (at 820) a notification identifying the list of network resources (e.g., endpoints) associated with the service. In some embodiments, the notification is an API (or YAML file) that specifies the list of network resources and a set of attributes of the network resources that are used to provide the service. For example, in order to provide load balancing across a set of endpoints identified in the list of network resources, the notification includes IP addresses of the identified network resources and ports on which the network resources listen. The list of network resources and attributes are then provided (at 825) to the service engines to facilitate the service and the process ends.

In some embodiments, facilitating the service at the service engines includes load balancing data messages destined to the service across identified network resources serving as service nodes or end nodes for the service. In such embodiments, the load balancing service engines receive the list of network resources and generate a set of load balancing rules or criteria (e.g., weight values for round robin selection of end nodes) to select a network resource from the received list. In some embodiments, the load balancing refers to an endpoint data structure received from the set of service engine controllers. Alternatively, facilitating the service includes serving as a proxy for the identified network resources that provide the service.

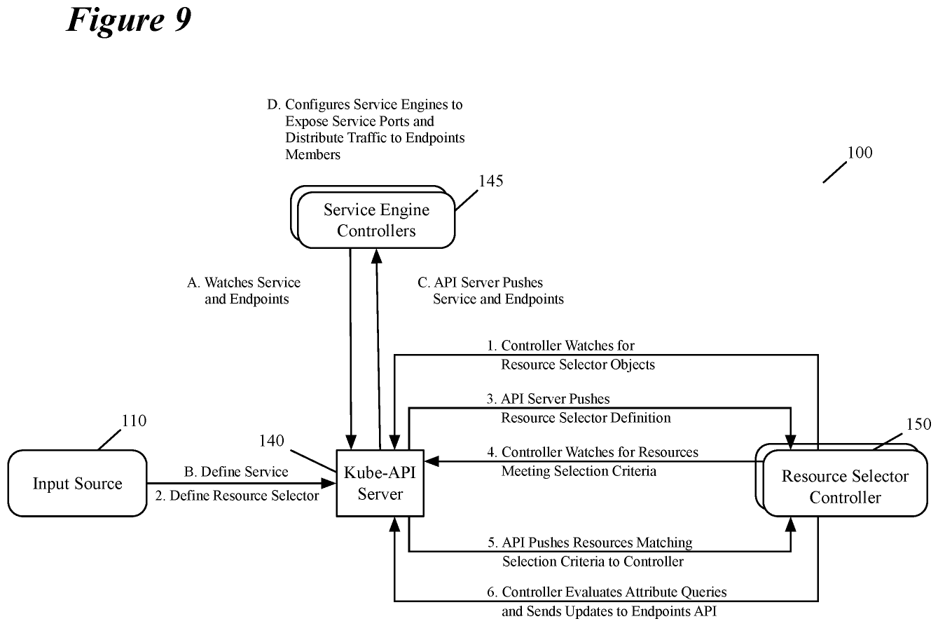

FIG. 9 illustrates a complete set of operations for a particular embodiment of the network control system using resource selectors. FIG. 9 illustrates a reduced view of network control system 100 including the input source 110, the API server 140, the service engine controllers 145, and resource selector controllers 150. FIG. 9 illustrates two related sets of operations (A-D and 1-6). The operations of FIG. 9 generally coincide with the operations of FIGS. 2, 4, 5, and 8. For example, operations “A,” “B,” “C,” and “D” correspond to operations 805; 205; 210, 445, 810, and 820; and 825, respectively. Operation “1” is not described above and is similar to operation “A” described above in relation to operations 805. Operation “1,” in some embodiments, includes registering for event notifications related to resource selector APIs or objects as part of a resource selector controller startup or configuration process. Operations “2,” “3,” “4,” “5,” and “6” correspond in large part to operations 220; 225 and 505; 520 and 405; 525 and 415; and 540 and 440.

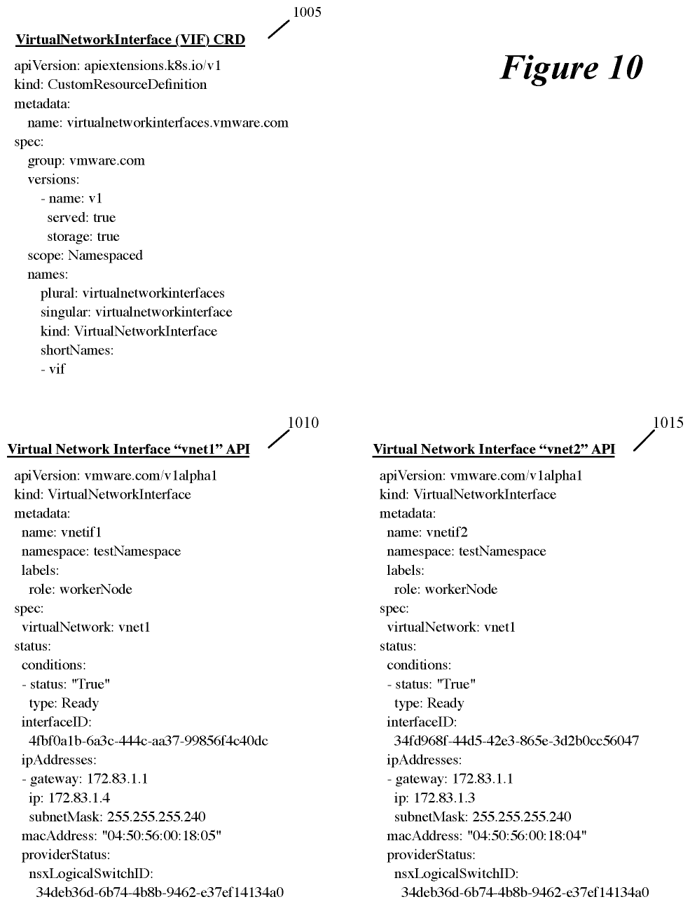

FIGS. 10-18 illustrate APIs that define different network resources, resource selector APIs for identifying network resources related to the service defined in service API 305, Endpoints APIs generated based on the resource selector APIs, and EndpointSlice APIs generated based on the resource selector APIs. FIG. 10 illustrates a CRD 1005 for a virtual network interface (VIF or “vnetif”) and two APIs 1010 and 1015 defining two VIFs (“vnet1” and “vnet2”) related to the service. The VIFs defined by APIs 1010 and 1015 are deployed in the same namespace (i.e., testNamespace) as the service 305 and are each labeled as a “workerNode” (matching the criterion 315d specified in the resource selector API 315).

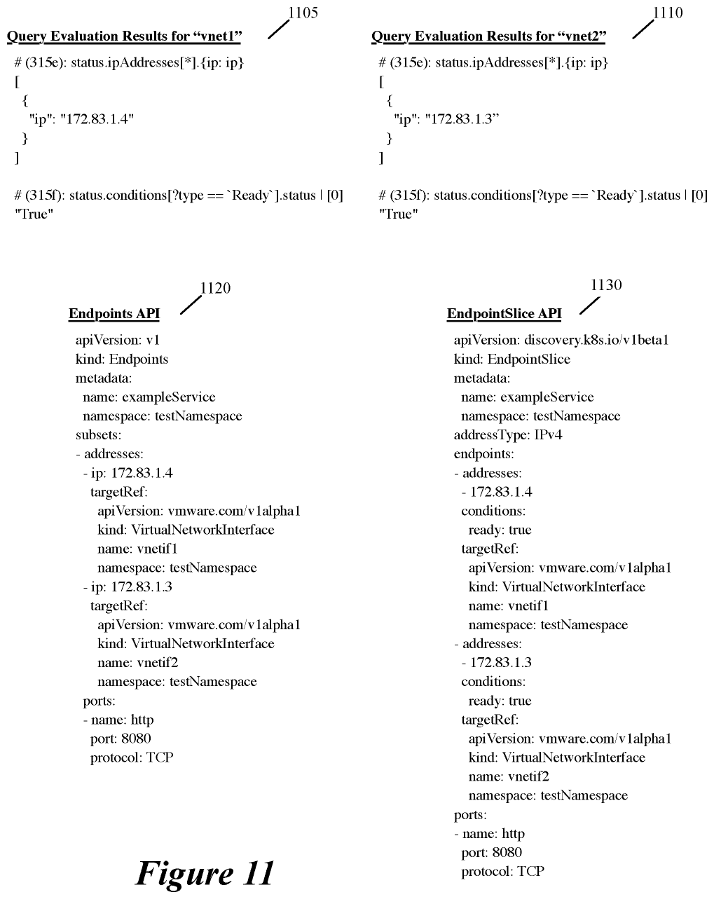

FIG. 11 illustrates a set of query results 1105 and 1110 of the JMESPath queries (315e and 315f) specified in the resource selector API 315 and an Endpoints API 1120 and EndpointSlice API 1130 generated based on the resource selector API and the related VIFs. Query results 1105 and 110 each include an IP address associated with the VIF (172.83.1.4 for “vnet1” and 172.83.1.3 for “vnet2”) and a status variable indicating that the VIF is operational or available (i.e., “Ready”=“True”). Based on the information in the resource collector API and the retrieved attributes, the resource selector populates a set of endpoint data structures indicated in the set of outputTo fields (e.g., an Endpoints API and an EndpointSlice API). One of ordinary skill in the art will appreciate that a resource selector can be defined to populate other types of data structures by specifying that type of data structure in an outputTo field.

Endpoints API 1120 and EndpointSlice API 1130 include a name shared by the service (i.e., “exampleService”) and a namespace in which the service is defined (i.e., “testNamespace”) and indicate that they are either an Endpoints or EndpointSlice object (indicated in the “kind” field). One of ordinary skill in the art will appreciate that the namespace is set to be the same as the service by default but may be different in other embodiments. Each API also includes the IP addresses identified for the VIFs and the hardcoded port values specified in the resource selector API (i.e., {name: http, port: 8080, protocol: TCP}). The Endpoints API 1120 and EndpointSlice API 1130 are defined in Kubernetes and can be consumed by components of Kubernetes (or third-party components made to integrate with Kubernetes) without further processing. As discussed above, the Endpoints API 1120 and EndpointSlice API 1130 are merely examples of native APIs that can be generated by a resource selector and one of ordinary skill will appreciate that the resource selector can be defined to generate arbitrary output.

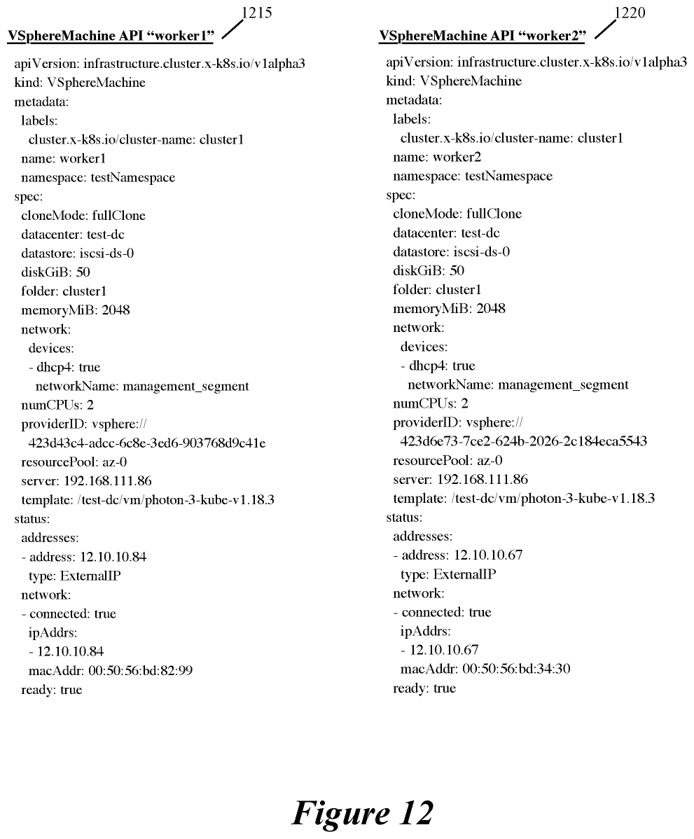

FIG. 12 illustrates APIs 1215 and 1220 for two VSphereMachines (“worker1” and “worker2”) that are defined by a CRD and are related to the service defined by API 305 of FIG. 3. As for APIs 1010 and 1015, APIs 1215 and 1220 are defined to be in the same namespace as the service. However, the labels defined in APIs 1215 and 1220 are different from the labels defined in APIs 1010 and 1015. APIs 1215 and 1220 also define an IP address associated with the VSphereMachine created by the API.

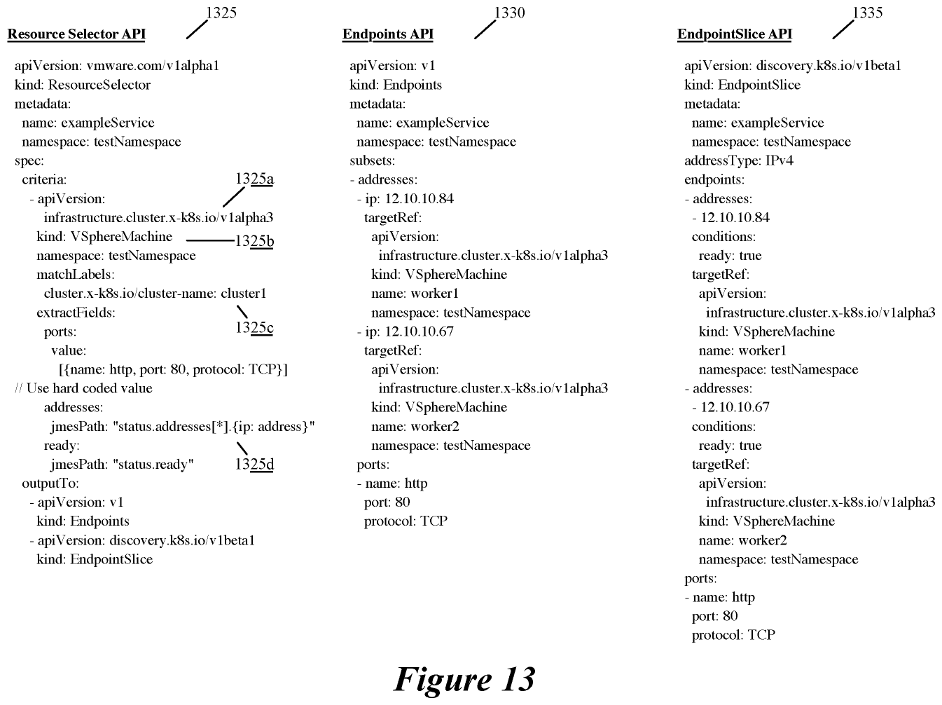

FIG. 13 illustrates a resource selector API 1325 for identifying the VSphereMachines defined by APIs 1215 and 1220 as being related to the service. Resource selector API 1325 identifies a different set of criteria 1325a and 1325b and a different label matching criterion 1325c that are specific to this type (“kind”) of resource. Additionally, the hardcoded port values and the JMESPath query 1325d specified in resource selector 1325 are different for this type of resource based on the attributes of the resource type and the structure of the resource definition. For example, the IP address of the VSphereMachine created by APIs 1215 and 1220 is located at “status.addresses.address” instead of being located at “status.ipAddresses.ip” for the VIF APIs 1010 and 1015. Accordingly, the JMESPath query 1325d specified for resource selector 1325 is “status.addresses[*]. {ip: address}” where the corresponding JMESPath query 315e specified for resource selector 315 is “status.ipAddresses[*]. {ip: ip}.”

Based on the information in the resource collector API 1325 and the retrieved attributes, the resource selector populates a set of endpoint data structures indicated in the set of outputTo fields (e.g., an Endpoints API and an EndpointSlice API). Endpoints API 1330 and EndpointSlice API 1335 are similar in structure to Endpoints API 1120 and EndpointSlice API 1130 as required by the definition of the Endpoints or EndpointSlice “kind.” For instance, Endpoints API 1330 and EndpointSlice API 1335 both specify a set of IP addresses for resources associated with the service, and a set of ports exposed by the resources. Additionally, the Endpoints API 1330 and EndpointSlice API 1335 identify a similar set of criteria for the resource (i.e., apiVersion, kind, name, and namespace).

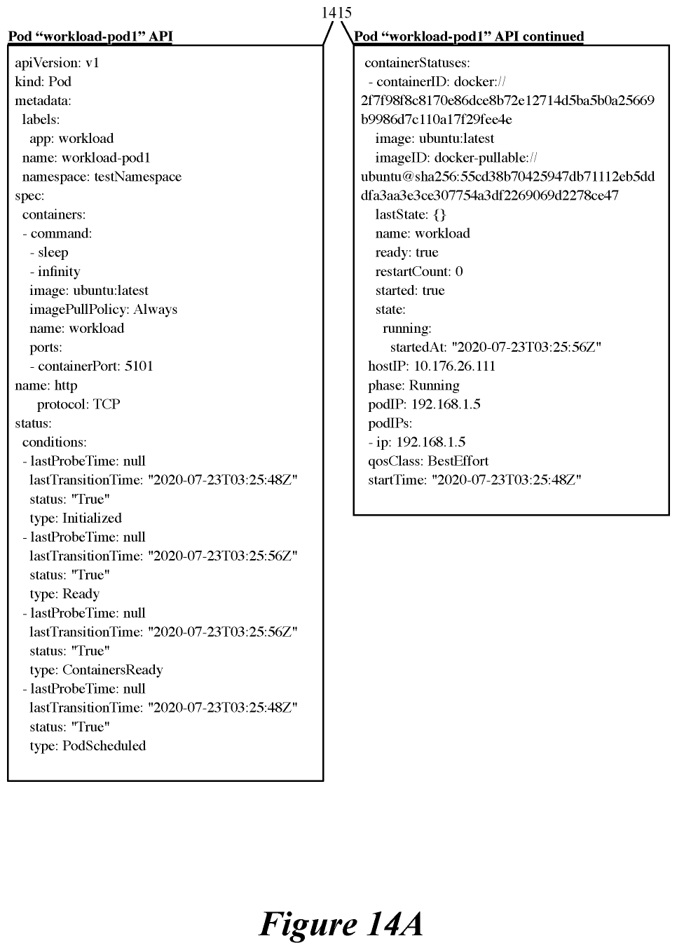

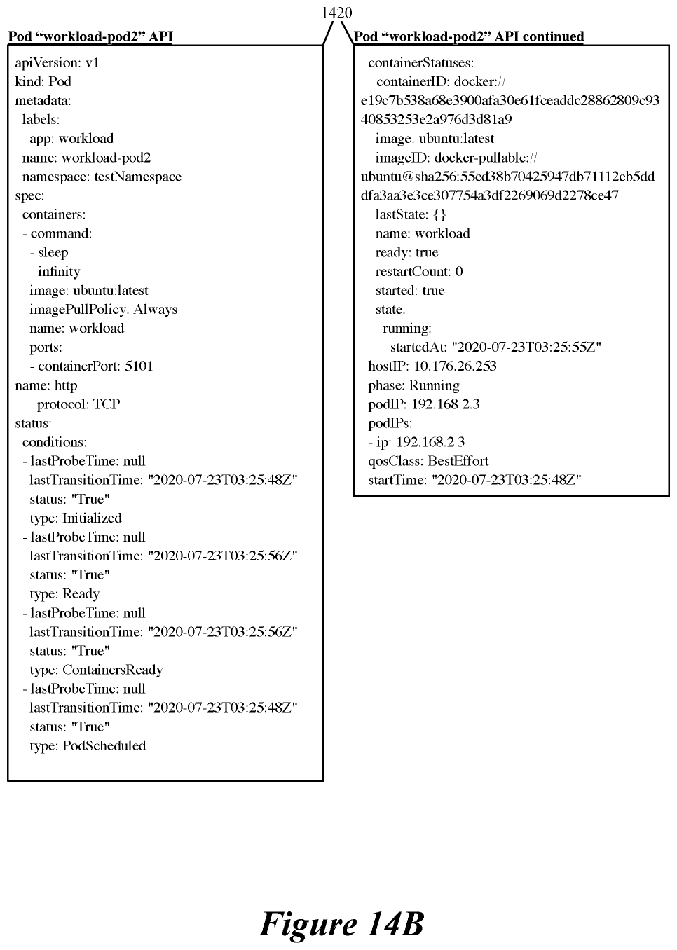

FIGS. 14A and B illustrate APIs 1415 and 1420 for two Pods (“workload-pod1” and “workload-pod2”) that are native Kubernetes resources and are related to the service defined by API 305 of FIG. 3. As for APIs 1010 and 1015, APIs 1415 and 1420 are defined to be in the same namespace as the service. However, the labels defined in APIs 1415 and 1420 (e.g., “app: workload”) are different from the labels defined in APIs 1010 and 1015. APIs 1415 and 1420 also define an IP address associated with the Pod and a name (i.e., http), port number (i.e., 5101), and a protocol (i.e., TCP) defining a set of port parameters for the Pod created by the API.

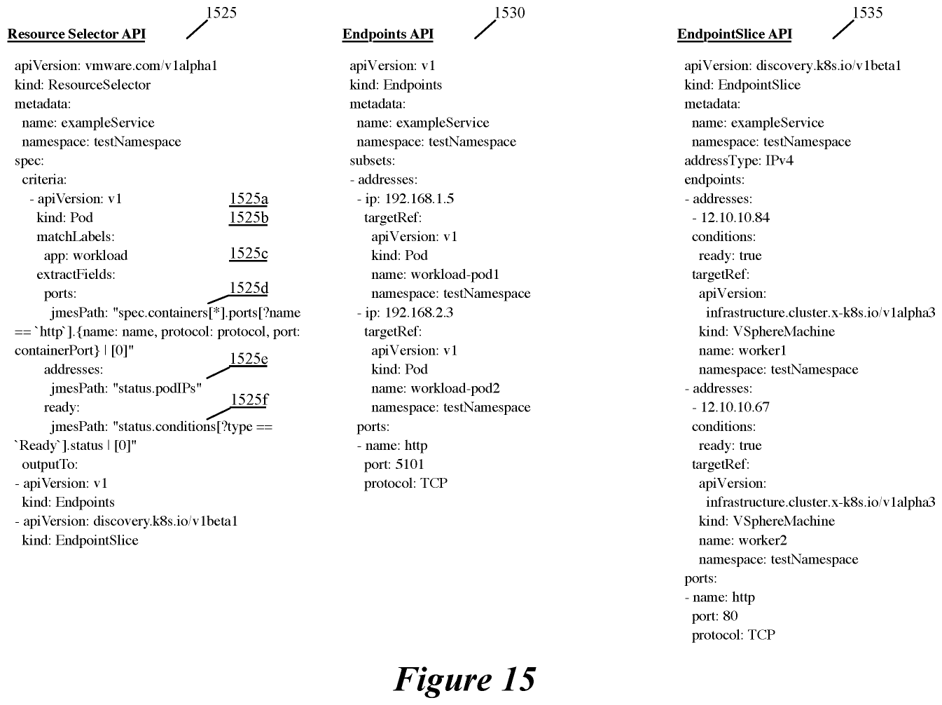

FIG. 15 illustrates a resource selector API 1525 for identifying the Pods defined by APIs 1415 and 1420 as being related to the service. Resource selector API 1525 identifies a different set of criteria 1525a and 1525b and a different label matching criterion 1525c that are specific to this type (“kind”) of resource. Additionally, the port values are not hardcoded for this resource type and the JMESPath query 1525d specified in resource selector 1525 retrieves the name, protocol, and port specified in the Pod APIs 1415 and 1420. Additionally, the JMESPath query 1525e is different for this type of resource based on the attributes of the resource type and the structure of the resource definition. For example, the IP address of the Pods created by APIs 1415 and 1420 is located at “status.podIPs” in the Pod API structure. Accordingly, the JMESPath query 1525e specified for resource selector 1525 is “status.podIPs” and the set of JMESPath queries 1525d-1525f for this resource type performed on the Pod defined by API 1415 return the following values:

[{“name”: “http”, “protocol”: “TCP”, “port”: 5101}]

[{“ip”: “192.168.1.5”}]

“True”

Based on the information in the resource collector API 1525 and the retrieved attributes, the resource selector populates a set of endpoint data structures indicated in the set of outputTo fields (e.g., an Endpoints API and an EndpointSlice API). Endpoints API 1530 and EndpointSlice API 1535 are similar in structure to Endpoints API 1120 and EndpointSlice API 1130 as required by the definition of the Endpoints or EndpointSlice “kind.” For instance, Endpoints API 1530 and EndpointSlice API 1535 both specify a set of IP addresses for resources associated with the service, and a set of ports exposed by the resources. Additionally, the Endpoints API 1530 and EndpointSlice API 1535 identify a similar set of criteria for the resource (i.e., apiVersion, kind, name, and namespace).

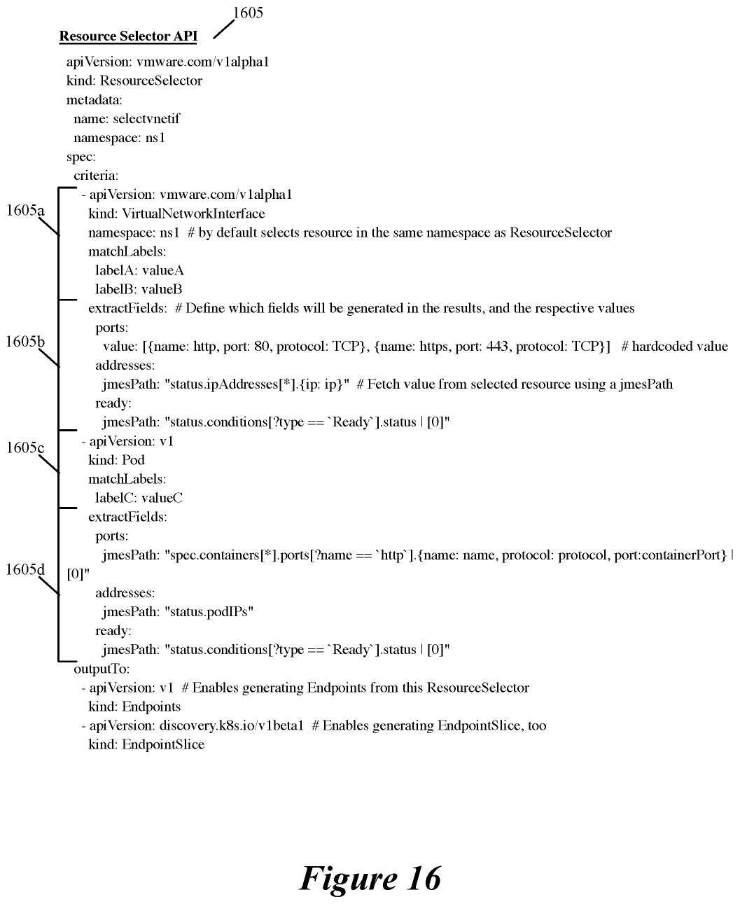

FIG. 16 illustrates an exemplary resource selector API 1605 that is defined using multiple type-specific sets of criteria 1605a and 1605c and multiple type-specific sets of queries 1605b and 1605d. The exemplary resource selector 1605 is specified to identify VIF objects using the “apiVersion,” “kind,” and “namespace” values and to select VIF objects for populating an Endpoints API or EndpointSlice API (e.g., as related to an associated service) based on a set of two “matchLabels” (“labelA: valueA” and “labelB: valueB”) that identify VIF objects as being candidates for inclusion in the generated API(s). The exemplary resource selector 1605 is further specified to identify Pod objects using the “apiVersion” and “kind” values and to select Pod objects for populating the Endpoints API or EndpointSlice API (e.g., as related to an associated service) based on a set of “matchLabels” including the single match criteria “labelC: valueC” that identifies Pod objects as being candidates for inclusion in the generated API(s).

The type-specific queries 1605b and 1605d are similar to those described above in relation to resource selector APIs 315 and 1525 of FIGS. 3 and 15, respectively. Resource selector APIs 305 and 1525 include a set of queries to retrieve (or extract) the information for a VIF and a Pod, respectively. Resource selector API 1605 includes a first set of type-specific queries 1605b to retrieve the information for a VIF and a second set of type-specific queries 1605d to retrieve the information for a Pod. One of ordinary skill in the art will appreciate that additional type-specific sets of criteria and queries may be included in other resource selector definitions and that type-specific sets of criteria and queries may be included for custom resources based on the structure and content of the CRD that defines the custom resource.

For example, a user can specify a set of criteria in a resource selector based on the definition (e.g., the CRD) of a newly-defined custom resource type (e.g., customResourceType1) in an API version (e.g., vX). The criteria, in some embodiments, may include “kind: customResourceType1” and “apiVersion: vX” with a label or set of labels defined for the custom resource type that can be used to identify a particular network resource of type “customResourceType1” as being related to a particular service or endpoint group associated with the resource selector. Based on the CRD, a user can also write a set of type-specific queries to retrieve the information necessary to populate an endpoint data structure.

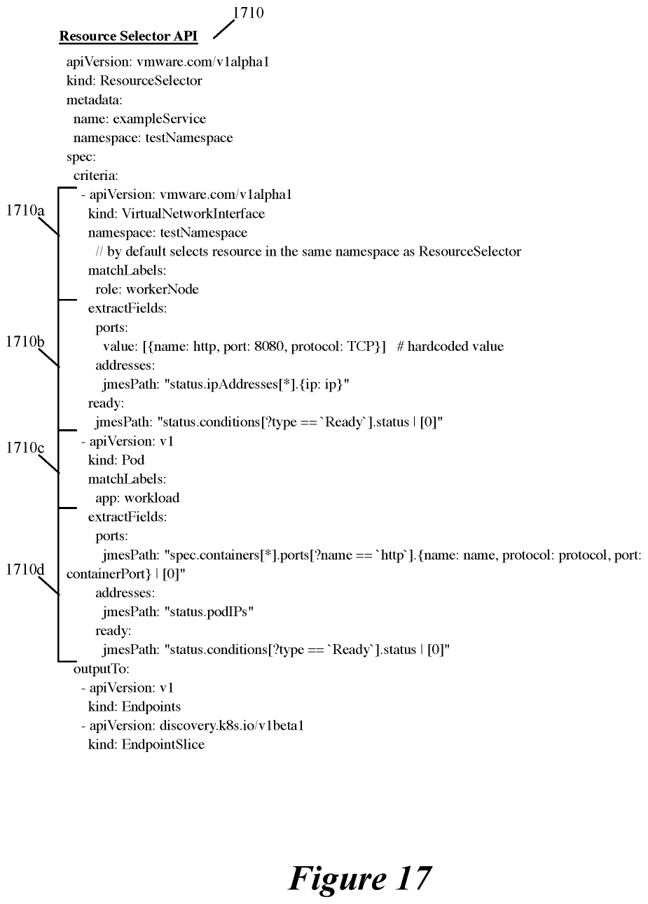

FIG. 17 illustrate an exemplary resource selector 1710 that is defined to populate an Endpoints API and EndpointSlice API with information relating to multiple network resource types (i.e., VIFs and Pods) related to the service “exampleService.” The resource selector is defined using multiple type-specific sets of criteria 1710a and 1710c and multiple type-specific sets of queries 1710b and 1710d. The exemplary resource selector 1710 is specified to identify VIF objects using the “apiVersion,” “kind,” and “namespace” values. The “matchLabels” list for VIF resources includes, in this embodiment, a single match label “role: workerNode” that is used to identify VIF objects for populating an Endpoints API or EndpointSlice API (e.g., identifying VIFs as related to the service). Resource selector 1710 is further specified to identify Pod objects using the “apiVersion” and “kind” values. The “matchLabels” list for Pod resources includes, in this embodiment, a single match label “app: workload” that is used to identify Pod objects for populating the Endpoints API or EndpointSlice API (e.g., identifying Pods as related to the service).

The type-specific queries 1710b and 1710d are the same as those described above in relation to resource selector APIs 305 and 1525 of FIGS. 3 and 15, respectively. As opposed to resource selectors APIs 315 and 1525 which each include only a single set of type-specific queries, resource selector API 1710 includes a first set of type-specific queries 1710b to retrieve the information for a VIF and a second set of type-specific queries 1710d to retrieve the information for a Pod. The retrieved information and criteria specified in the resource selector API are used to populate an Endpoints API, an EndpointSlice API, or both.

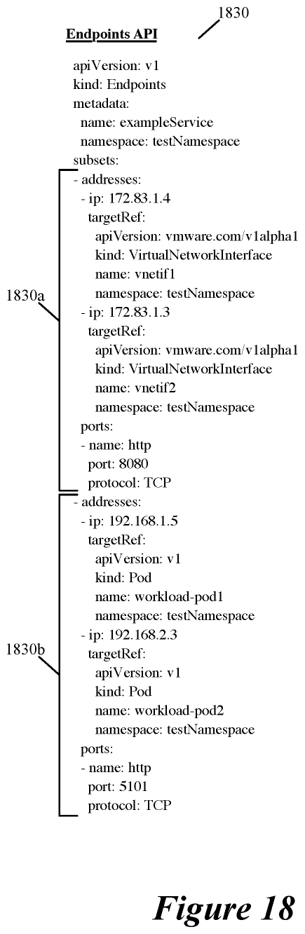

FIG. 18 illustrates an Endpoints API 1830 generated based on resource selector 1710 and APIs 1010, 1015, 1415, and 1420. Endpoints API 1830 is similar to the Endpoints APIs 1120 and 1530 of FIGS. 11 and 15. However, Endpoints API 1830 specifies network resources of multiple types in a single Endpoints API. Because the different types of network resources identified as endpoints for the service in the Endpoints API 1830 listen on different ports, Endpoints API 1830 includes two sets of “addresses” that each include a different set of port attributes. For additional network resource types using a same set of port attributes, IP addresses would be added to the list of addresses with the correct set of port attributes. For additional network resource types using a different set of port attributes, a new set of “addresses” would be added to with the new set of port attributes.

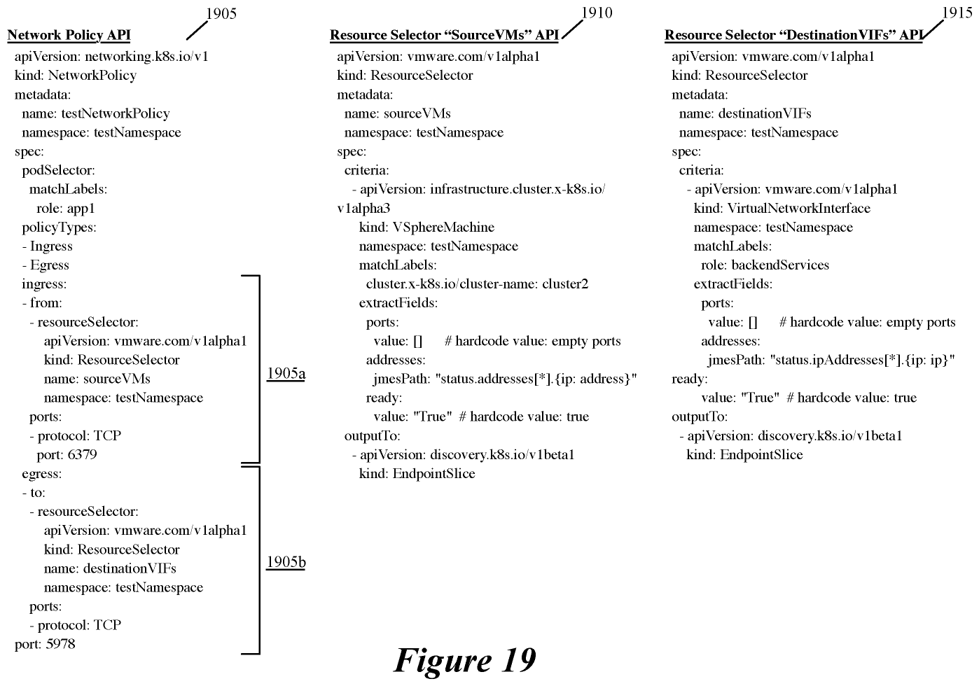

The resource selector CRD and resource selector controller, in some embodiments, are used to generate dynamic groups of network resources of arbitrary resource types, and meeting arbitrary criteria, specified by a user for consumption by a network policy (e.g., a Kubernetes NetworkPolicy). FIG. 19 illustrates a network policy API 1905 that defines a network policy (“kind: NetworkPolicy”) in terms of resource selectors (at 1905a and 1905b) defined in resource selector APIs 1910 and 1915. Network policy API 1905 specifies a set of Pods to which the network policy will be applied using a set of “matchLabels” that define a “podSelector” (e.g., Pods with “role: app1”). The ingress policy 1905a identifies a set of machines (i.e., network resources) from which communication to the Pods covered by the network policy is allowed and identifies the ports on which that communication is allowed. Similarly, the egress policy 1905b identifies a set of machines (i.e., network resources) to which communication from the Pods covered by the network policy is allowed and identifies the ports on which that communication is allowed.

In the example of FIG. 19, resource selector API 1910 selects a set of VSphereMachines with a particular label (i.e., “cluster.x-k8s.io/cluster-name: cluster2”) and identifies a set of IP addresses associated with all VSphereMachines with the particular label. As shown in API 1910, the ports values are hardcoded as empty because the ports are defined in the network policy API (i.e., “protocol: TCP”, “port: 6379”). Similarly, the ready value is hardcoded to “True” to apply the policy to all VSphereMachines matching the specified label. In some embodiments, this is because applying a policy to a non-operational VSphereMachine causes no problems, whereas not including an identified VSphereMachine (e.g., a VSphereMachine that becomes operational between updates to the related Endpoints API) could drop traffic that should not be dropped.

Similarly, resource selector API 1915 selects a set of VIFs with a particular label (i.e., “role: backendServices”) and identifies a set of IP addresses associated with all VIFs with the particular label. As shown in API 1915, the ports values are hardcoded as empty because the ports are defined in the network policy API (i.e., “protocol: TCP”, “port: 5978”). Similarly, the ready value is hardcoded to “True” to apply the policy to all VIFs matching the specified label. In some embodiments, this is because applying a policy to a non-operational VIF causes no problems, whereas not including an identified VIF (e.g., a VIF that becomes operational between updates to the related Endpoints API) could drop traffic that should not be dropped. One of ordinary skill in the art will appreciate that resource selector APIs specified by a network policy would, in some embodiments, identify multiple types of network resources including native and non-native resource types as in FIGS. 16 and 17.

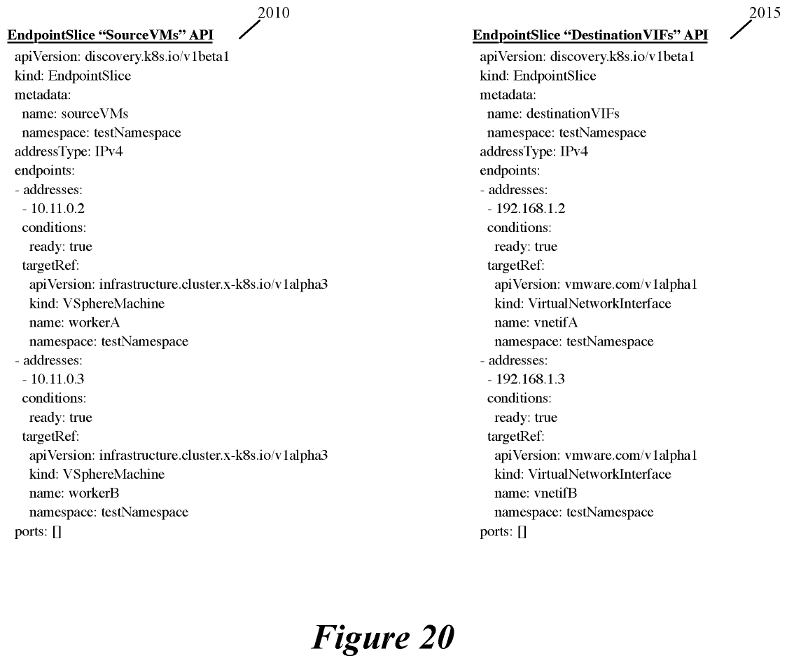

FIG. 20 illustrates EndpointSlice APIs 2010 and 2015 generated based on resource selector APIs 1910 and 1915, respectively. EndpointSlice APIs 2010 and 2015 have the same form as EndpointSlice APIs for the VSphereMachines and VIFs in FIGS. 13 and 11, respectively, but omit a port value (i.e., include an empty set of port attribute values) as the port values are specified in the network policy API 1905.

As for the use of resource selectors for services, using resource selectors to identify endpoints (e.g., machines, Pods, VMs, or other network resources) associated with ingress and egress rules allows a user to specify a dynamic group of network resources of multiple types including custom resources. Accordingly, the definition of the network resources allowed to communicate with the Pods covered by the network policy (either for ingress or egress) can be finer-grained when compared to using an “ipBlock” (i.e., a set of IP addresses specified in a CIDR (Classless Inter-Domain Routing) notation), a “namespaceSelector” (i.e., a selector that specifies all Pods in a selected namespace), or a “podSelector” (i.e., a selector that selects Pods matching a specified set of labels) to define the ingress or egress rules.

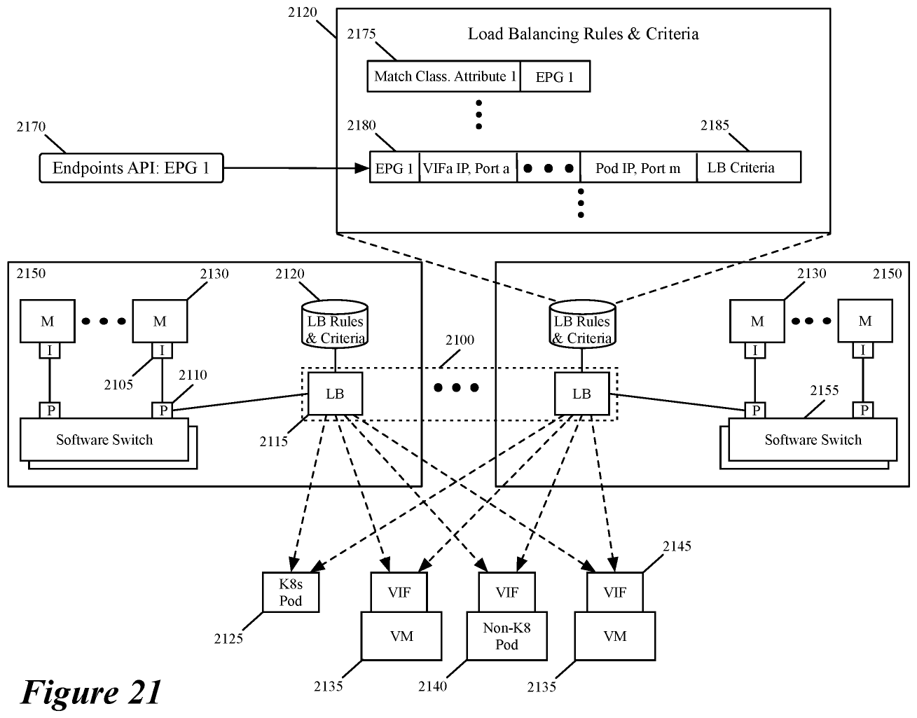

FIG. 21 illustrates an example of distributed load balancer 2100 that is defined for several VIF-associated machines 2130 on several host computers 2150 and that uses a set of endpoint data structures (e.g., “Endpoints API: EPG 1” 2170) generated based on a resource selector to identify network resources (e.g., end nodes or service nodes) to which to distribute load balanced data messages. In some embodiments, software switch ports 2110 to which the VIFs 2105 connect (i.e., with which the VIFs are associated) are configured with hooks to load balancers 2115 executing on the same host computers as the VIFs. In some embodiments, one load balancer 2115 is instantiated for each VIF that needs associated client-side load balancing operations. Each load balancer in some embodiments is a service engine provided by a hypervisor executing on the same computer as the machines 2130. The load balancer engines 2115, in some embodiments, are managed by a set of service engine controllers and receive the endpoint data structures from the set of service engine controllers. In other embodiments, the load balancer engines 2115 individually register for updates to endpoint data structures.

The hooks are configured to direct to their respective load balancers ingress and/or egress traffic entering or exiting (provided by or provided to) the VIF-associated machines. Each load balancer 2115 uses a set of load balancing rules 2175 (stored in an LB rule storage 2120) that specifies load balancing rules in terms of endpoint groups (i.e., EPG1). The LB rule storage 2120 also stores a list of endpoint groups 2180 that are based on the set of endpoint data structures (e.g., Endpoints API 2170) generated based on the resource selector to identify the set of service nodes that should process data message flows entering or exiting the machines 2130. The list of endpoint groups 2180, in some embodiments, includes a set of load balancing criteria 2185 that is specified for the endpoint group. In other embodiments, the set of load balancing rules 2175 includes the set of load balancing criteria 2185.

In some embodiments, the set of service nodes includes service nodes of different resource types such as Kubernetes Pod 2125, VMs 2135, and non-Kubernetes Pod 2140. The VMs 2135 and Pod 2140, in some embodiments, are identified by the load balancer by the associated VIFs 2145. In some embodiments, the load balancer 2115 then uses load balancing criteria (e.g., weight values for round robin selection of end nodes) to select an end node for each data message flow, and then forwards one or more data messages of a flow to the end node selected for that flow.

The end nodes 2125, 2135, and 2140 in some embodiments can be service nodes in case of ingress or egress traffic, or destination compute nodes in case of egress traffic. The end nodes can be engines/machines on the same host computer 2150 as the client VIF-associated machines and the load balancers, can be engines/machines on different host computers, or can be standalone appliances. In some embodiments, the end nodes are associated with a virtual network address (e.g., a VIP address) or a set of associated network addresses (e.g., a set of associated IP addresses). In some embodiments, the end nodes machines are Pods, VMs, and/or containers executing on Pods/VMs.

When forwarding data messages to end node machines residing on the same host computer, a load balancer 2115 forwards the data messages through a software switch 2155 on its host computer 2150 in some embodiments. Alternatively, when forwarding data messages to end node machines not residing on the same host computer, the load balancer 2115 forwards the data messages through its host's software switch 2155 and/or software routers (not shown) and intervening network fabric. The VIF-associated ports 2110 are also configured with hooks for other middlebox service operations, such as firewall, intrusion detection, intrusion prevention, deep packet inspection, encryption, etc. that may be provided by other sets of end nodes identified based on other resource selectors.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

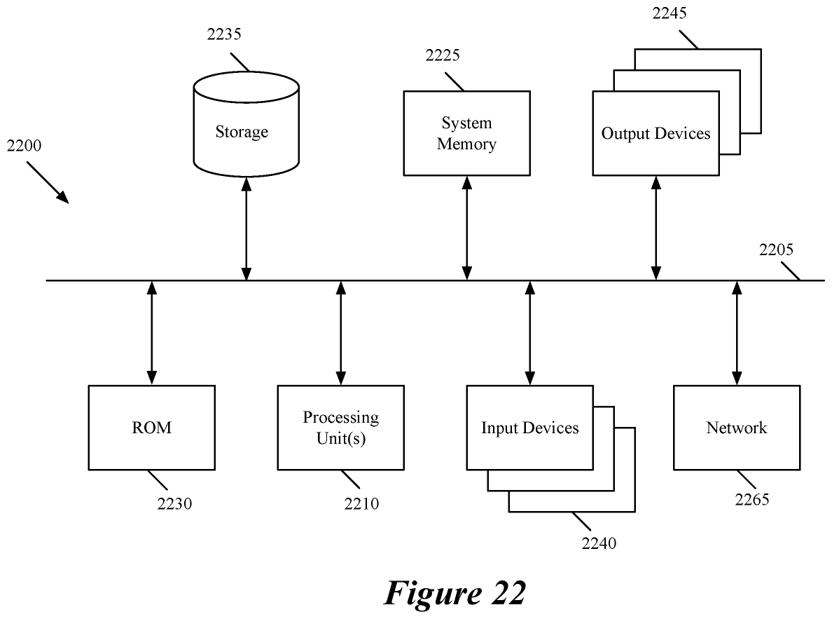

FIG. 22 conceptually illustrates a computer system 2200 with which some embodiments of the invention are implemented. The computer system 2200 can be used to implement any of the above-described hosts, controllers, and managers. As such, it can be used to execute any of the above described processes. This computer system includes various types of non-transitory machine readable media and interfaces for various other types of machine readable media. Computer system 2200 includes a bus 2205, processing unit(s) 2210, a system memory 2225, a read-only memory 2230, a permanent storage device 2235, input devices 2240, and output devices 2245.

The bus 2205 collectively represents all system, peripheral, and chipset buses that communicatively connect the numerous internal devices of the computer system 2200. For instance, the bus 2205 communicatively connects the processing unit(s) 2210 with the read-only memory 2230, the system memory 2225, and the permanent storage device 2235.

From these various memory units, the processing unit(s) 2210 retrieve instructions to execute and data to process in order to execute the processes of the invention. The processing unit(s) may be a single processor or a multi-core processor in different embodiments. The read-only-memory (ROM) 2230 stores static data and instructions that are needed by the processing unit(s) 2210 and other modules of the computer system. The permanent storage device 2235, on the other hand, is a read-and-write memory device. This device is a non-volatile memory unit that stores instructions and data even when the computer system 2200 is off. Some embodiments of the invention use a mass-storage device (such as a magnetic or optical disk and its corresponding disk drive) as the permanent storage device 2235.

Other embodiments use a removable storage device (such as a floppy disk, flash drive, etc.) as the permanent storage device. Like the permanent storage device 2235, the system memory 2225 is a read-and-write memory device. However, unlike storage device 2235, the system memory is a volatile read-and-write memory, such as random access memory. The system memory stores some of the instructions and data that the processor needs at runtime. In some embodiments, the invention's processes are stored in the system memory 2225, the permanent storage device 2235, and/or the read-only memory 2230. From these various memory units, the processing unit(s) 2210 retrieve instructions to execute and data to process in order to execute the processes of some embodiments.

The bus 2205 also connects to the input and output devices 2240 and 2245. The input devices 2240 enable the user to communicate information and select requests to the computer system. The input devices include alphanumeric keyboards and pointing devices (also called “cursor control devices”). The output devices 2245 display images generated by the computer system. The output devices include printers and display devices, such as cathode ray tubes (CRT) or liquid crystal displays (LCD). Some embodiments include devices such as touchscreens that function as both input and output devices.

Finally, as shown in FIG. 22, bus 2205 also couples computer system 2200 to a network 2265 through a network adapter (not shown). In this manner, the computer can be a part of a network of computers (such as a local area network (“LAN”), a wide area network (“WAN”), or an Intranet), or a network of networks (such as the Internet). Any or all components of computer system 2200 may be used in conjunction with the invention.

Some embodiments include electronic components, such as microprocessors, that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Several embodiments were described above that use certain CRDs. One of ordinary skill will realize that other embodiments use other types of CRDs. For instance, some embodiments use LB monitor CRDs so that load balancing monitors can be created through APIs that refer to such a CRD. LB monitors in some embodiments provide statistics to reflect the usage and overall health of the load balancers. Also, while several examples above refer to container Pods, other embodiments use containers outside of Pods. Thus, one of ordinary skill in the art would understand that the invention is not to be limited by the foregoing illustrative details, but rather is to be defined by the appended claims.

We claim:

1. A method for identifying network resources related to a first intent-based Application Programming Interface (API) request for a service to be implemented for a network, the method comprising:
at an API server,
receiving a second API request for a resource selector relating to the requested service that specifies (1) sets of criteria for identifying network resources related to the requested service and (2) sets of queries for retrieving information associated with network resources identified by the sets of criteria;
identifying, based on the sets of criteria, a set of network resources related to the requested service; and
populating a set of endpoint data structures with (1) a group of network resources in the identified set of related network resources and (2) information retrieved using queries in the sets of queries, wherein the set of endpoint data structures are used to identify network resources used to implement the requested service.

2. The method of claim 1, wherein the resource selector is a network resource type defined by a custom resource definition (CRD) and the second API references the resource selector CRD.

3. The method of claim 2, wherein the API server deploys the requested resource collector and a resource selector controller is deployed to monitor the deployed resource selector.

4. The method of claim 3, wherein the API server receives the first intent-based API request and the second API request from a user, and the resource selector controller:
receives the second API request from the API server;
generates a registration for notification of events related to network resources related to the sets of criteria; and
sends the generated registration to the API server,
wherein identifying the set of network resources related to the requested service is based on the received registration.

5. The method of claim 4, wherein
the identified set of related network resources is sent to the resource selector controller,
the resource selector controller performs queries in the sets of queries on the identified set of network resources, and
populating the set of endpoint data structures comprises populating the set of endpoint data structures based on receiving at least one of an Endpoints API request and an EndpointSlice API request generated based on the identified set of network resources and the results of the queries performed by the resource selector controller.

6. The method of claim 1, wherein the set of endpoint data structures is provided to a set of service engines that facilitate implementing the requested service.

7. The method of claim 6, wherein the set of service engines performs a load balancing operation to distribute received packets associated with the requested service among the group of network resources in the set of endpoint data structures.

8. The method of claim 1, wherein the specified sets of criteria comprise a set of type-specific criteria for each of a plurality of network resource types.

9. The method of claim 8, wherein a set of type-specific criteria specified for a first network resource type in the plurality of network resource types is different from a set of type-specific criteria specified for a second network resource type in the plurality of network resource types.

10. The method of claim 9, wherein the network comprises a Kubernetes network and the plurality of network resource types comprises a non-native network resource type.

11. The method of claim 10, wherein the non-native network resource type is defined by a custom resource definition (CRD) that defines attributes of the non-native network resource type.

12. The method of claim 11, wherein the set of type-specific criteria specified for the non-native network resource type comprises an attribute defined in the CRD.

13. The method of claim 8, wherein
populating the set of endpoint data structures further comprises populating the endpoint data structures with attribute information, for each network resource type included in the set of identified set of related network resources, based on the set of type-specific criteria used to identify the related network resources of the network resource type, and
the attribute information for a particular network resource type comprises an API version, a kind, and a namespace associated with the set of type-specific criteria.

14. The method of claim 13, wherein
a first set of type-specific criteria specifies a first API version, a first kind, and a first namespace,
a second set of type-specific criteria specifies a second API version, a second kind, and a second namespace, and
the first API version and first kind are different from the second API version and second kind, respectively, and the first namespace is the same as the second namespace.

15. The method of claim 1, wherein the sets of queries for retrieving information comprise a set of type-specific queries used to retrieve relevant information for each of a plurality of network resources types.

16. The method of claim 15, wherein
the network comprises a Kubernetes network and the plurality of network resource types comprises a non-native network resource type defined by a custom resource definition (CRD) that defines attributes of the non-native network resource type,
the sets of type-specific queries comprise JavaScript Object Notation (JSON) Matching Expression Paths (JMESPath) queries.

17. The method of claim 15, wherein a first set of type-specific queries specified for a first network resource type in the plurality of network resource types is different from a second set of type-specific queries specified for a second network resource type in the plurality of network resource types.

18. The method of claim 17, wherein a first query in the first set of type-specific queries and a second query in the second set of type-specific queries retrieve the same type of information.

19. The method of claim 18, wherein the type of information retrieved by the first and second queries comprises one of an internet protocol (IP) address associated with a network resource and a status value indicating whether the network resource is available, wherein when the status value associated with a particular network resource indicates that the network resource is unavailable, the information for the particular network resource is not used to populate the endpoint data structure.

20. The method of claim 1, wherein the network comprises a Kubernetes network and the identified set of network resources comprise a first network resource of a first type of Kubernetes network resource and a second network resource of a second type of non-native network resource.

21. The method of claim 1, wherein, the identified set of related network resources to the requested service is a first identified set of related network resources and the group of network resources is a first set of network resources, the method further comprising:
after receiving modified sets of criteria for identifying network resources related to the requested service, identifying a second set of network resources related to the requested service base on the modified sets of criteria; and
populating the set of endpoint data structures with (1) a second group of network resources in the identified second set of related network resources and (2) information retrieved using queries in the sets of queries,
wherein, when the first and second groups of network resources are different, the API server provides the set of endpoint data structures including the second group of network resources to a set of service engines that performs a load balancing operation for the requested service that updates a set of load balancing rules based on the differences between the first and second groups of network resources.
